(19) United States
(12) Patent Application Publication
(10) Pub. No.: US 2026/0323658 A1
(43) Pub. Date: Oct. 15, 2026

(54) SIGNALING DEMODULATION REFERENCE SIGNAL (DMRS) SYMBOL PRESENCE

(71) Applicant: T-Mobile USA, Inc., Bellevue, WA (US)

(72) Inventors: Yu WANG, Fairfax, VA (US); Zheng FANG, McLean, VA (US)

(21) Appl. No.: 19/645,049

(22) Filed: Apr. 10, 2026

Related U.S. Application Data
(63) Continuation-in-part of application No. 19/180,101, filed on Apr. 15, 2025.

(51) Int. Cl. H04W 72/232

(52) U.S. Cl. CPC H04W 72/232

(57) ABSTRACT

Disclosed solutions provide intelligent demodulation reference signal (DMRS) allocation. When a user equipment (UE) is in good signal conditions, such as stationary, with low interference, strong received power, and slowly varying channel characteristics, multiple DMRS symbols are not needed for reliable demodulation. Rather, the downlink (DL) and/or uplink (UL) signal qualities are monitored, so that the count of DMRS symbols used (in each direction) may be optimized. This permits reliable demodulation in poorer signal conditions, while improving data throughput in better signal conditions, by approximately 10% (on the DL; UL is slightly lower). For example, DMRS symbol count may be reduced from two per time slot to only one, and in some scenarios, if signal conditions are sufficiently good, some slots may be skipped and have no DMRS symbols at all. Some examples may place a single DMRS symbol per slot in position 7 (i.e., the slot center).

### CROSS REFERENCE TO RELATED APPLICATION

This application is a continuation-in-part application of and claims priority to U.S. patent application Ser. No. 19/180,101, entitled “INTELLIGENT DEMODULATION REFERENCE SIGNAL (DMRS) ALLOCATION,” filed on Apr. 15, 2025, the disclosure of which is incorporated herein by reference in its entirety.

### BACKGROUND

Demodulation reference signal (DMRS) symbols are used to provide a reference for assisting in demodulation, in order to reduce bit error rate (BER) in at least fifth-generation (5G) cellular systems. Later cellular generations may use symbols that are equivalent to 5G DMRS symbols. DMRS symbols may be used for both a downlink (DL) traffic channel, such as a physical downlink shared channel (PDSCH), and an uplink (UL) traffic channel, such as a physical uplink shared channel (PUSCH). That is, both the cell site and user equipment (UE), such as mobile cellphones and stationary fixed wireless access (FWA) devices and customer premises equipment (CPE), may both transmit and receive DMRS symbols.

### SUMMARY

The following summary is provided to illustrate examples disclosed herein, but is not meant to limit all examples to any particular configuration or sequence of operations.

Solutions are disclosed that signal demodulation reference signal (DMRS) symbol presence. In some examples, a wireless network transmits an indicator, which identifies whether a first downlink (DL) slot (not an idle slot) includes a DMRS symbol, in a DL scheduling message to a user equipment (UE). In some examples, a UE transmits an indicator, which identifies whether a first uplink (UL) slot includes a DMRS symbol, in a UL scheduling message to a wireless network. Additional examples use a pair of timers, a short timer and a long timer (one pair for the DL channel and one pair for the UL channel), to identify whether to include a DMRS symbol, based on at least the variation of the DL or UL channel condition.

### BRIEF DESCRIPTION OF THE DRAWINGS

The disclosed examples are described below with reference to the accompanying drawing figures listed below, wherein:

FIG. 1 illustrates an exemplary architecture that advantageously provides intelligent demodulation reference signal (DMRS) allocation;

FIGS. 2A, 2B, and 2C illustrate various scenarios for both downlink (DL) and uplink (UL) channels that require differing counts of DMRS symbols, as may be encountered by examples of the architecture of FIG. 1;

FIGS. 3A and 3B show charts of channel conditions versus the number (count) of DMRS symbols used per DL and UL slot.

FIG. 4 illustrates further detail for a component of the architecture of FIG. 1;

FIGS. 5A, 5B, and 5C illustrate exemplary DL slots, as may be used in examples of the architecture of FIG. 1;

FIGS. 6A, 6B, and 6C illustrate exemplary UL slots, as may be used in examples of the architecture of FIG. 1;

FIGS. 7A, 7B, 8A, 8B, 8C, and 8D illustrate flowcharts of exemplary operations associated with the architecture of FIG. 1;

FIGS. 9A and 9B illustrate an enhanced version of the component of the architecture of FIG. 1, which is shown in FIG. 4.

FIG. 10 shows a set of messages that flow between a user equipment (UE) and a wireless network of examples of the architecture of FIG. 1;

FIGS. 11A and 11B illustrate flowcharts of exemplary operations associated with the architecture of FIG. 1;

FIGS. 12A, 12B, 12C, and 12D illustrate examples of some of the messages that are indicated in FIG. 10;

FIGS. 13A, 13B, and 13C illustrate flowcharts of exemplary operations associated with the architecture of FIG. 1; and

FIG. 14 illustrates a block diagram of a computing device suitable for implementing various aspects of the disclosure.

Corresponding reference characters indicate corresponding parts throughout the drawings. References made throughout this disclosure, relating to specific examples, are provided for illustrative purposes, and are not meant to limit all implementations or to be interpreted as excluding the existence of additional implementations that also incorporate the recited features.

### DETAILED DESCRIPTION

Disclosed solutions provide intelligent demodulation reference signal (DMRS) allocation and signal DMRS symbol presence. When a user equipment (UE) is in good signal conditions, such as stationary, with low interference, strong received power, and slowly varying channel characteristics, multiple DMRS symbols are not needed for reliable demodulation. Rather, the downlink (DL) and/or uplink (UL) signal qualities are monitored, so that the count of DMRS symbols used (in each direction) may be optimized. This permits reliable demodulation in poorer signal conditions, while improving data throughput in better signal conditions, by approximately 10% (on the DL; UL is slightly lower). For example, DMRS symbol count may be reduced from two per time slot to only one, and in some scenarios, if signal conditions are sufficiently good (for example, when UE is connected to Fixed Wireless Access network (FWA)), some slots may be skipped and have no DMRS symbols at all. Some examples may place a single DMRS symbol per slot in position 7 (i.e., the slot center).

Multiple DMRS symbols (e.g., two) are typically used per time slot (i.e., one fourth of a frame) within a single frequency, replacing a data symbol. Although this displaces data, cutting into potential throughput, it accommodates user equipment (UEs) that are in poor signal conditions, such as low signal power, high interference levels, and/or moving rapidly (which introduces a Doppler effect). However, when a UE is in good signal conditions, such as stationary in place, with low interference and strong DL and UL received power, the multiple DMRS symbols are not needed and are thus superfluous. This means that data throughput capacity is being unnecessarily reduced.

Aspects of the disclosure improve the data-carrying capacity of wireless networks, for example, improving spectral efficiency, by optimizing the count of DMRS symbols used for the channel conditions (e.g., in both DL and UL, optimized individually). These advantageous results are accomplished, at least in part, by determining a DL or UL channel condition and, based on at least the channel condition, selecting a count of DMRS symbols to use in slots of the traffic channel. For example, in some embodiments, when a UE is connected to a Fixed Wireless Access (FWA) network, the DL and/or UL channel conditions are typically good. Some examples determine whether to use a DMRS symbol in each non-idle slot of the traffic channel, and transmit data in some slots without any DMRS symbols.

As illustrated in the foregoing discussion and as will be discussed in further detail herein, the present disclosure utilizes a variety of terms to describe features and advantages of methods and systems described herein. Some of these terms will be discussed in further detail below.

For example, a “wireless network” refers to a group of interconnected nodes that facilitate the exchange of messages and signals. In one or more implementations, a wireless network includes nodes such as server devices that are connected by links (i.e., wired or wireless). Often, a wireless network includes sophisticated routing systems that move messages and signals among the nodes of the network. In one or more implementations, a wireless network as discussed herein includes a fourth-generation (4G) mobile communication network (e.g., cellular network), a fifth-generation (5G) mobile communication network, and may further include later generations, such as sixth-generation (6G). A wireless network may have a core network that performs as a backbone of nodes that is generally considered to be a crucial part of the network, and may include multiple layers. For example, a core network (CN) may include an access layer that connects UEs with the network, a core layer that handles connectivity and user services, and a distribution layer that connects the access layer with the core layer.

Additionally, DMRS symbols are used for demodulation of signals from channels that may have noise and/or multipath effects. It is a known symbol that enables characterization of the channel, in order to improve demodulation accuracy for other (unknown) data symbols. Downlink control information (DCI) and uplink control information (UCI) are information, such as scheduling information (e.g., allocating physical resources) for the physical downlink shared channel (PDSCH) and the physical uplink shared channel (PUSCH). The PDSCH and PUSCH are the radio channels used for carrying data on the DL and UL, respectively. DCI also specifies modulation and coding schemes.

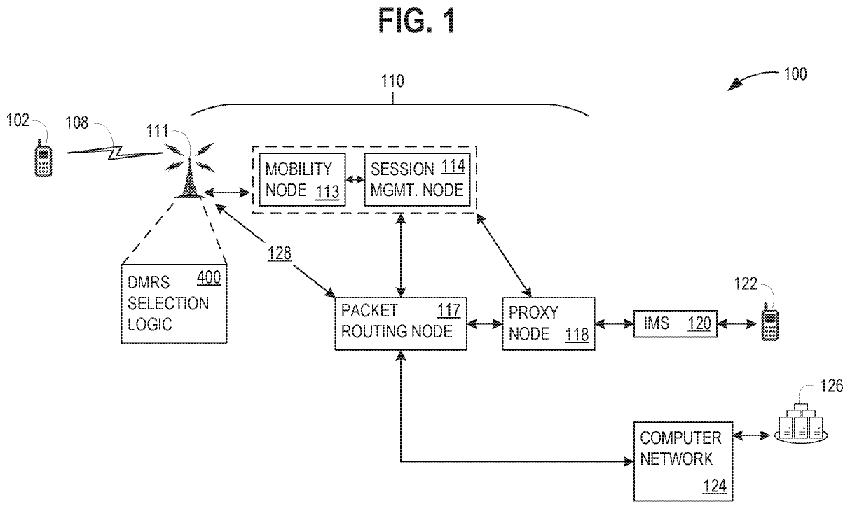

With reference now to the figures, FIG. 1 illustrates an exemplary architecture 100 that advantageously provides intelligent DMRS allocation and signals DMRS symbol presence in slots with data (i.e., not idle slots). A wireless network 110 is illustrated that is serving a UE 102. UE 102 may be an enhanced mobile broadband (eMBB) or cellphone, a fixed wireless access (FWA), a consumer premises equipment (CPE), an internet of things (IoT) device, a machine-to-machine (M2M) communication device, a personal computer (PC, e.g., desktop, notebook, tablet, etc.) with a cellular modem, or another telecommunications device capable of using a wireless network. In the scene depicted in FIG. 1, UE 102 is using wireless network 110 for a packet data session to reach a network resource 126 (e.g., a website) across an external packet data computer network 124 (e.g., the internet). In some scenarios, UE 102 may use wireless network 110 for a phone call with another UE 122. Wireless network 110 may be a cellular network such as a fifth-generation (5G) network, a fourth-generation (4G) network, or another cellular generation network. In some contexts, 5G is also referred to as new radio (NR), and standalone 5G, which is a full 5G implementation that does not rely on 4G technology for some functionality, may be referred to as SA NR.

UE 102 uses an air interface 108 to communicate with a base station 111 of wireless network 110, such that base station 111 is the serving base station for UE 102 (providing the serving cell). In some scenarios, base station 111 may be referred to as a radio access network (RAN). In some embodiments, the base station 111 is configured to receive information of the type of access network to which UE 102 is connected. For example, UE 102 may be connected to a cellular access network. In another example, UE 102 may be connected to a fixed wireless access network. Wireless network 110 has a mobility node 113, a session management node 114, and other components (not shown). Wireless network 110 also has a packet routing node 117 and a proxy node 118. Mobility node 113 and session management node 114 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with packet routing node 117, and proxy node 118. Packet routing node 117 is in communication with proxy node 118 and computer network 124. In some 5G examples, base station 111 comprises a gNodeB (gNB), mobility node 113 comprises an access mobility function (AMF), session management node 114 comprises a session management function (SMF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), and packet routing node 117 comprises an SAEGW-user plane (SAEGW-U). In some examples, proxy node 118 comprises a proxy call session control function (P-CSCF) in both 4G and 5G.

Proxy node 118 is in communication with an internet protocol (IP) multimedia system (IMS) 120, which uses an access gateway (IMS-AGW) in order to provide connectivity to other wireless (cellular) networks, such as for a call with a UE 122 or a public switched telephone system (PSTN, also known as plain old telephone system, POTS). In some examples, proxy node 118 may be considered to be within IMS 120. UE 102 reaches network resource 126 using computer network 124 (or IMS 120, in some examples). Data packets of data traffic 128 to/from UE 102 pass through at least base station 111 and packet routing node 117 on their way from/to computer network 124 or IMS 120 (via proxy node 118).

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

As illustrated in further detail in the remaining figures, a DMRS selection logic 400 determines (e.g., estimates) channel conditions for DL and/or UL directions, and determines how many DMRS symbols to use in each slot. Although DMRS selection logic 400 is illustrated as being located within base station 111, in some examples, DMRS selection logic 400 may be located elsewhere within wireless network 110, and/or distributed among multiple locations.

Although FIG. 1 and some of the following figures are described using an example of a cellular network, it should be understood that the teachings herein are applicable to other types of wireless networks. To benefit from the teachings herein, another wireless network, other than a cellular network, should use a DMRS symbol, where DMRS is interpreted to be a generic term, rather than specifically a 5G DMRS symbol. With such features, another type of wireless network, other than a cellular network, may also benefit from the disclosure herein.

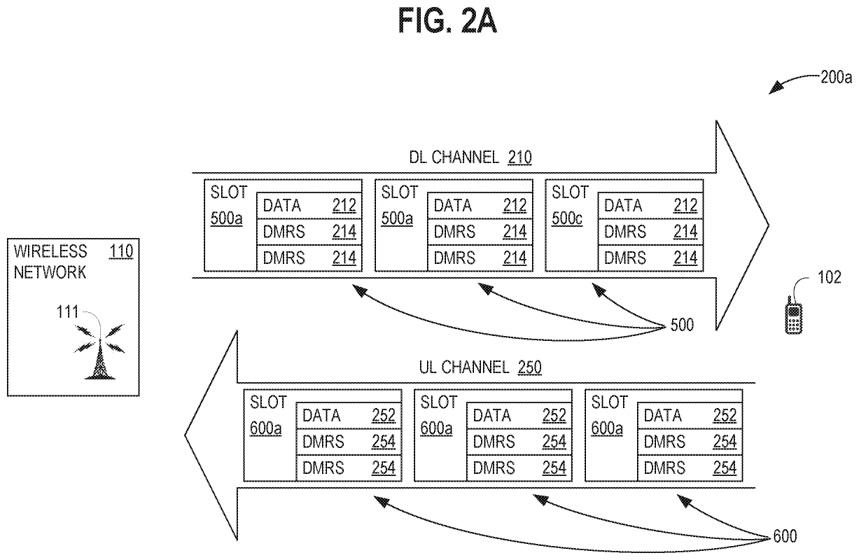

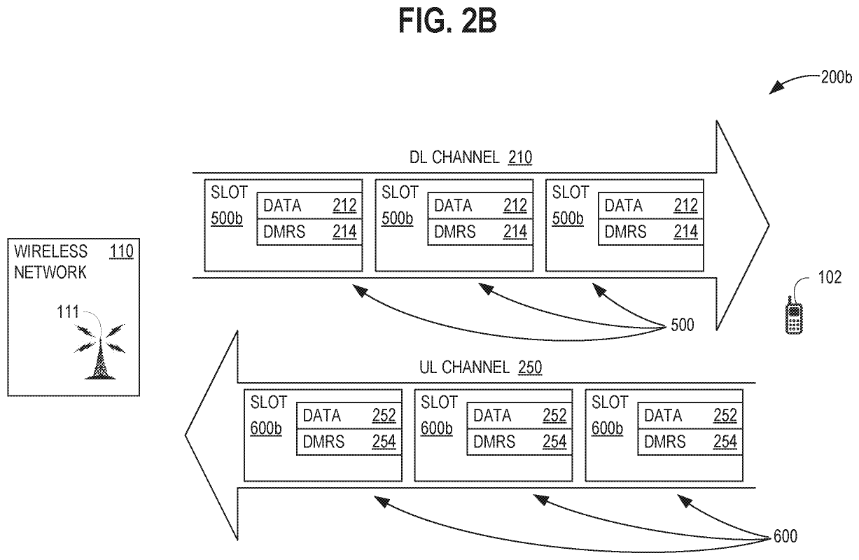

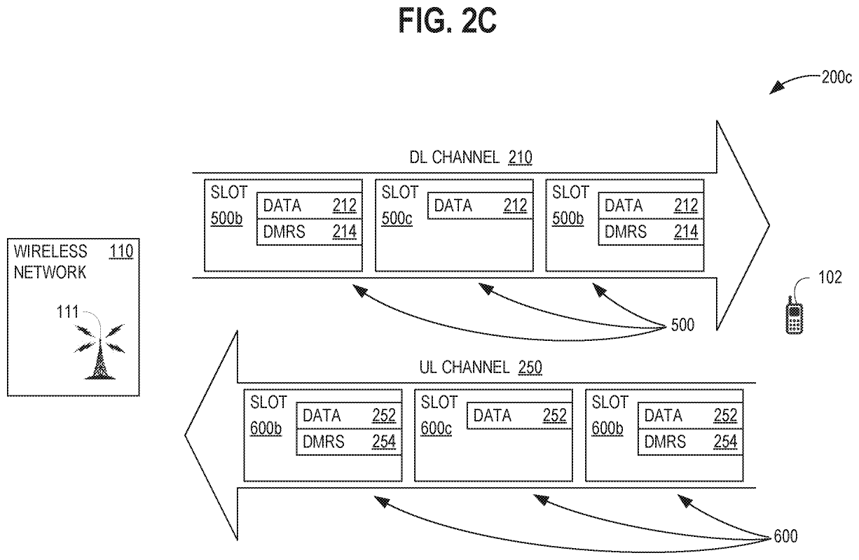

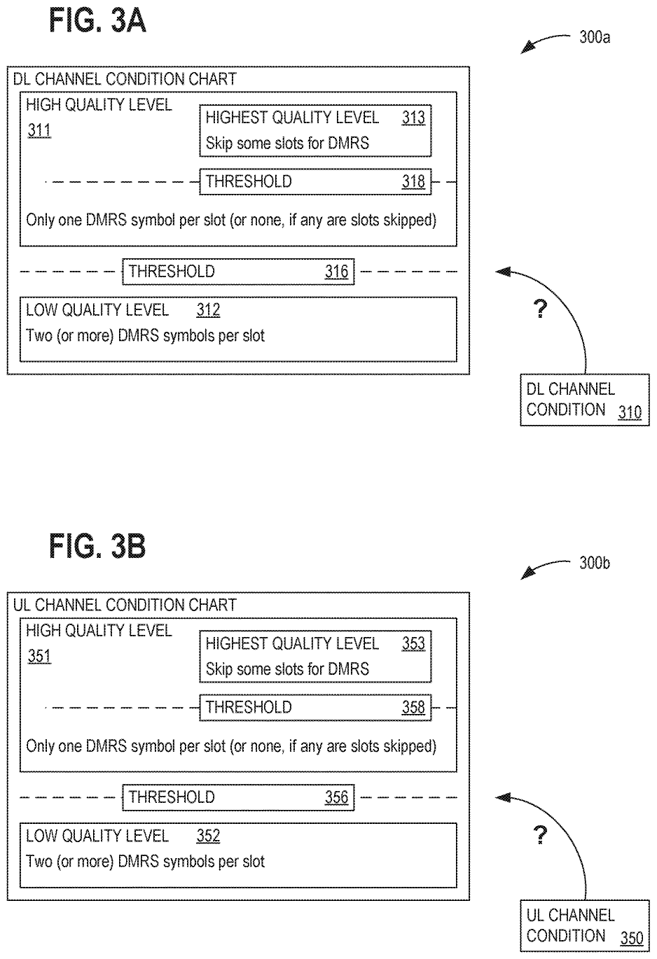

FIGS. 2A, 2B, and 2C illustrate various scenarios for both DL and UL channels that require differing counts of DMRS symbols. FIG. 2A illustrates a scenario 200a with poor signal quality, in which two DMRS symbols 214 are required per slot for DL and two DMRS symbols 254 are required per slot for UL. DL and UL DMRS symbols may be the same or may be different. Scenario 200a is associated with quality level 312 for DL and quality level 352 for UL, although the signal quality levels for DL and UL may differ in real-world conditions. Quality levels 312 and 352 are explained in relation to FIGS. 3A and 3B, respectively. Some examples may use more than two DMRS symbols per slot.

Base station 111 transmits data 212 (DL data) to UE 102 over a DL traffic channel 210, which may be a physical downlink shared channel (PDSCH). Three DL slots 500 are shown, although in 5G a frame has four slots. A first DL slot 500a has two DMRS symbols 214 in addition to data 212. A second DL slot 500a also has two DMRS symbols 214 in addition to data 212, and a third DL slot 500a also has two DMRS symbols 214 in addition to data 212.

UE 102 transmits data 252 (UL data) to base station 111 over a UL traffic channel 250, which may be a physical uplink shared channel (PUSCH). Three UL slots 600 are shown, although in 5G a frame has four slots. A first UL slot 600a has two DMRS symbols 254 in addition to data 252. A second UL slot 600a also has two DMRS symbols 254 in addition to data 252, and a third UL slot 600a also has two DMRS symbols 254 in addition to data 252.

FIG. 2B illustrates a scenario 200b with higher signal quality than scenario 200a, in which only a single DMRS symbol 214 is required per slot for DL and a single DMRS symbol 254 is required per slot for UL. Scenario 200b is associated with quality level 311 for DL and quality level 351 for UL. Quality levels 311 and 351 are also explained in relation to FIGS. 3A and 3B, respectively.

For DL traffic channel 210, three DL slots 500 are shown. A first DL slot 500b has one DMRS symbol 214 in addition to data 212. A second DL slot 500b also has one DMRS symbol 214 in addition to data 212, and a third DL slot 500b also has one DMRS symbol 214 in addition to data 212. For UL traffic channel 250, three UL slots 600 are shown. A first UL slot 600a has one DMRS symbol 254 in addition to data 252. A second UL slot 600a also has one DMRS symbol 254 in addition to data 252, and a third UL slot 600a also has one DMRS symbol 254 in addition to data 252. This means that both DL slots 500 and UL slots 600 are able to carry more data in scenario 200b than in scenario 200a, because some data 212 can take the place of DMRS symbol 214 and some data 252 can take the place of DMRS symbol 254.

FIG. 2C illustrates a scenario 200c with an even higher signal quality than scenario 200b, in which a DMRS symbol 214 is not required in every slot for DL or for UL. Scenario 200c is associated with quality level 313 for DL and quality level 353 for UL. Quality levels 313 and 353 are also explained in relation to FIGS. 3A and 3B, respectively.

For DL traffic channel 210, three DL slots 500 are shown. A first DL slot 500b has one DMRS symbol 214 in addition to data 212. A DL slot 500c does not have a DMRS symbol 214, making room for more data 212. Another DL slot 500b returns to having one DMRS symbol 214 in addition to data 212. In this case, only one DL slot 500 is skipped for a DMRS, although some examples may skip more than one slot. Some examples may align skipping with frames, such that the first slot of a frame always has a DMRS symbol 214 (meaning that one or three immediately subsequent slots are skipped, but not two). For UL traffic channel 250, three UL slots 600 are shown. A first UL slot 600b has one DMRS symbol 254 in addition to data 252. A UL slot 600c is does not have a DMRS symbol 254, making room for more data 252. Another UL slot 600b returns to having one DMRS symbol 254 in addition to data 252. The skipping of more than a single slot may be handled the same for UL as described for DL. Both DL slots 500 and UL slots 600 are able to carry more data in scenario 200c than in scenario 200b.

FIG. 3A shows a chart 300a for determining a DL channel condition 310. Chart 300a has a signal quality threshold 316 that separates a higher quality level 311 from a lower quality level 312. In some examples, when DL traffic channel 210 has DL channel condition 310 at quality level 311, only one DMRS symbol 214 is used per DL slots 500a, 500b, and 500c (as shown in scenario 200b of FIG. 2B), and when DL traffic channel 210 has DL channel condition 310 at quality level 312, two DMRS symbols 214 are used per DL slot 500a, 500b, and 500c (as shown in scenario 200a of FIG. 2A).

In some examples, quality level 311 is further divided using a signal quality threshold 318 to identify a highest quality level 313 that may be considered to be a subset of quality level 311. In some examples, when DL traffic channel 210 has DL channel condition 310 at quality level 313, some slots are skipped, as shown in scenario 200c of FIG. 2C. That is, there is only one DMRS symbol 214 every N>1 slots, with N-1 slots being skipped.

Thus, DL channel condition 310 is within quality level 311 when DL channel condition 310 exceeds signal quality threshold 316 for a plurality of UE feedback signals 410 that includes UE feedback signal 410a. DL channel condition 310 is within quality level 313 when DL channel condition 310 exceeds a second signal quality threshold 318. Quality level 313 indicates a higher signal quality than quality level 311, which in turn indicates a higher signal quality than quality level 312.

Similarly, FIG. 3B shows a chart 300b for determining a UL channel condition 350. Chart 300b has a signal quality threshold 356 that separates a higher quality level 351 from a lower quality level 352. In some examples, when UL traffic channel 250 has UL channel condition 350 at quality level 351, only one DMRS symbol 254 is used per UL slots 600a, 600b, and 600c (as shown in scenario 200b of FIG. 2B), and when UL traffic channel 250 has UL channel condition 350 at quality level 352, two DMRS symbols 254 are used per UL slot 600a, 600b, and 600c (as shown in scenario 200a of FIG. 2A).

In some examples, quality level 351 is further divided using a signal quality threshold 358 to identify a highest quality level 353 that may be considered to be a subset of quality level 351. In some examples, when UL traffic channel 250 has UL channel condition 350 at quality level 353, some slots are skipped, as shown in scenario 200c of FIG. 2C. That is, there is only one DMRS symbol 254 every N>1 slots, with N-1 slots being skipped.

Thus, UL channel condition 350 is within quality level 351 when UL channel condition 350 exceeds signal quality threshold 356 for a plurality of UE reference signals 450 that includes UE reference signal 450a. UL channel condition 350 is within quality level 353 when UL channel condition 350 exceeds a second signal quality threshold 358. Quality level 353 indicates a higher signal quality than quality level 351, which in turn indicates a higher signal quality than quality level 352.

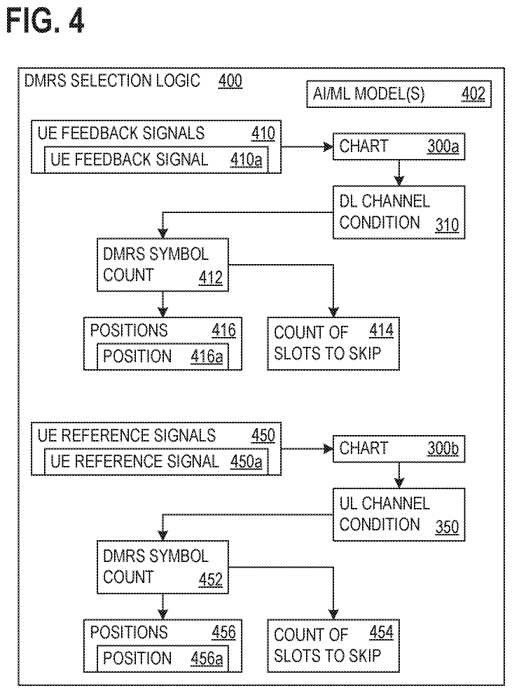

FIG. 4 illustrates further detail for DMRS selection logic 400. DMRS selection logic 400 determines DL channel condition 310 and UL channel condition 350, and selects a count 412 of DMRS symbols 214 to use for DL traffic channel 210 and a count 452 of DMRS symbols 254 to use for UL traffic channel 250. It is considered equivalent functionality, for purposes of this disclosure, to either (a) make an explicit channel condition determination and then select a count of DMRS symbols to use, or (b) select the count of DMRS symbols to use directly from channel quality information without explicitly identifying the channel condition.

For example, DMRS selection logic 400 is shown as having an artificial intelligence (AI) model 402 and collecting UE feedback signals 410 to determine DL channel condition 310 and then count 412 of DMRS symbols 214. AI model 402 may represent a single AI model or a collection of multiple AI models, each with a different training. As used herein, machine learning (ML) is interchangeable with AI. Different AI models may be used for UL versus DL tasks, and for determining channel conditions versus selecting how many slots to skip, for example. AI model 402 may use UE feedback signals 410 to determine DL channel condition 310, and then selection of count 412 of DMRS symbols 214 is straightforward. Or, equivalently, AI model 402 may use UE feedback signals 410 to determine count 412 of DMRS symbols 214 directly, and DL channel condition 310 is never explicitly identified.

A plurality of UE feedback signals 410 have a UE feedback signal 410a, and others that are similar, are collected over time and may be averaged or otherwise combined. UE feedback signal 410a may be channel state information (CSI) or a measurement report (MR), or similar information. CSI may be any of a hybrid automatic repeat request (HARQ) acknowledgment (ACK) signal, a HARQ negative acknowledgment (NACK) signal, a channel quality indicator (CQI), a precoding matrix indicator (PMI), or something similar. A MR may be reference signal received power (RSRP), reference signal received quality (RSRQ), a signal-to-interference-plus-noise ratio (SINR), or something similar.

DL channel condition 310 is determined in accordance with chart 300a of FIG. 3A, which then indicates count 412 of DMRS symbols 214. This enables determining positions 416 of DMRS symbols 214 in each of DL slots 500, or determining a position 416a for a single DMRS symbol 214. In some examples, a count 414 of DL slots 500 to skip for DMRS symbols 214 is also determined. AI model 402 may determine count 414 either separately from, or together with determining count 412 of DMRS symbols 214 or DL channel condition 310.

Determination of UL channel condition 350, a count 452 of DMRS symbols 254 to use for UL traffic channel 250, positions 456 of DMRS symbols 254, and a count 454 of UL slots 600 to skip are determined similarly as described for their DL equivalents. A plurality of UE reference signals 450 have a UE reference signal 450a, and others that are similar, are collected over time and may be averaged or otherwise combined. UE reference signal 450a may be a DMRS symbol on UL traffic channel 250 or a sounding reference signal (SRS), or something similar.

UL channel condition 350 is determined in accordance with chart 300b of FIG. 3B, which then indicates count 452 of DMRS symbols 254. This enables determining positions 456 of DMRS symbols 254 in each of UL slots 600, or determining a position 456a for a single DMRS symbol 254. In some examples, a count 454 of UL slots 600 to skip for DMRS symbols 254 is also determined. AI model 402 may determine count 454 either separately from, or together with determining count 452 of DMRS symbols 254 or UL channel condition 350.

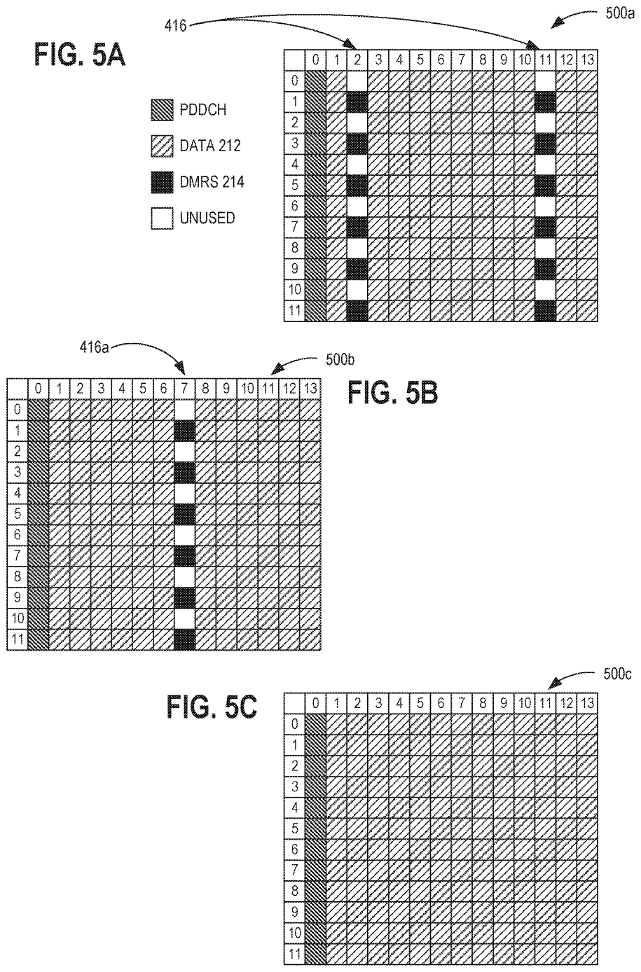

FIG. 5A shows DL slot 500a with two DMRS symbols 214, as per scenario 200a of FIG. 2A. References herein to one or two DMRS symbols per slot (for both DL and UL) mean one or two DMRS symbols per frequency in a slot, for those frequencies that have a DMRS symbol. As shown in FIG. 5A, the grid of 12 by 14 resource elements (REs) has 12 rows of different frequencies and 14 columns in time, with the position numbers using 0-based indexing, such that the 12^{th} row is position number 11, and the 14^{th} column is position number 13.

There are four usage classes for the REs of DL slot 500a: physical downlink control channel (PDCCH), data 212, DMRS symbol 214, and unused (empty) REs. In some examples that use power boost, the energy that would have otherwise been used for unused (empty) REs is available for instead increasing the amount of power in the REs used for DMRS symbol 214. PDCCH REs occupy position number 0 in time for every frequency. The two DMRS symbol 214 positions 416 are position number 2 (first half of DL slot 500a) and position number 11 (second half of DL slot 500a). However, only every other frequency has a DMRS symbol 214, which are the frequencies at odd-valued position numbers 1, 3, 5, 7, 9, and 11. In FIG. 5A, there are 132 REs with data 212: 11 columns in time, and 12 frequencies.

FIG. 5B shows DL slot 500b with one DMRS symbol 214, as per scenario 200b of FIG. 2B. The grid of 12 by 14 REs has 12 rows of different frequencies and 14 columns in time. PDCCH REs occupy position number 0 in time for every frequency. The single DMRS symbol 214 position 416a is position number 7, which is in the middle of DL slot 500a, although position number 2 or position number 11 could instead be used. Only every other frequency has a DMRS symbol 214. In FIG. 5B, there are 144 REs with data 212: 12 columns in time, and 12 frequencies. This is an increase of 9% compared with scenario 200a.

FIG. 5C shows DL slot 500c that includes data but without any DMRS symbol 214, as per scenario 200c of FIG. 2C. The grid of 12 by 14 REs has 12 rows of different frequencies and 14 columns in time. PDCCH REs occupy position number 0 in time for every frequency. In FIG. 5C, there are 156 REs with data 212: 12 columns in time, and 13 frequencies. This is an increase of 18% compared with DL slot 500a of scenario 200a (two DMRS symbols 214) and an increase of 8% compared with DL slot 500b of scenario 200b—although only a subset of DL slots 500 may be skipped as is shown for DL slot 500c.

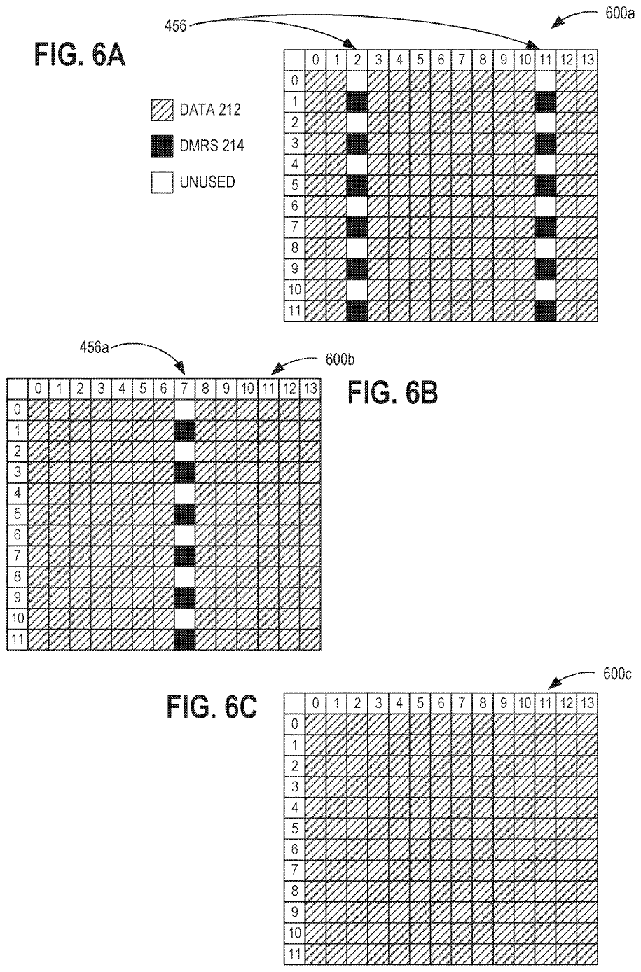

FIG. 6A shows UL slot 600a with two DMRS symbols UL4, as per scenario 200a of FIG. 2A. As shown in FIG. 6A, the grid of 12 by 14 REs has 12 rows of different frequencies and 14 columns in time. There are three usage classes for the REs of UL slot 600a: data 252, DMRS UL4, and unused (empty) REs (no PDCCH). In some examples that use power boost, the energy that would have otherwise been used for unused (empty) REs is available for instead increasing the amount of power in the REs used for DMRS symbol 254. The two DMRS symbol 254 positions 456 are position number 2 (first half of UL slot 600a) and position number 11 (second half of UL slot 600a). However, only every other frequency has a DMRS symbol 254, which are the frequencies at odd-valued position numbers 1, 3, 5, 7, 9, and 11. In FIG. 6A, there are 144 REs with data 252: 12 columns in time, and 12 frequencies.

FIG. 6B shows UL slot 600a with one DMRS symbol 254, as per scenario 200b of FIG. 2B. The grid of 12 by 14 REs has 12 rows of different frequencies and 14 columns in time. The single DMRS symbol 254 position 456a is position number 7, which is in the middle of UL slot 600a, although position number 2 or position number 11 could instead be used. Only every other frequency has a DMRS symbol 254. In FIG. 6B, there are 156 REs with data 252: 12 columns in time, and 13 frequencies. This is an increase of 8% compared with scenario 200a.

FIG. 6C shows UL slot 600b without any DMRS symbol 254, as per scenario 200c of FIG. 2C. The grid of 12 by 14 REs has 12 rows of different frequencies and 14 columns in time. In FIG. 6C, there are 168 REs with data 252: 12 columns in time, and 14 frequencies. This is an increase of 17% compared with UL slot 600a of scenario 200a (two DMRS symbols 254) and an increase of 8% compared with UL slot 600a of scenario 200b-although only a subset of UL slots 600 may be skipped as is shown for UL slot 600b.

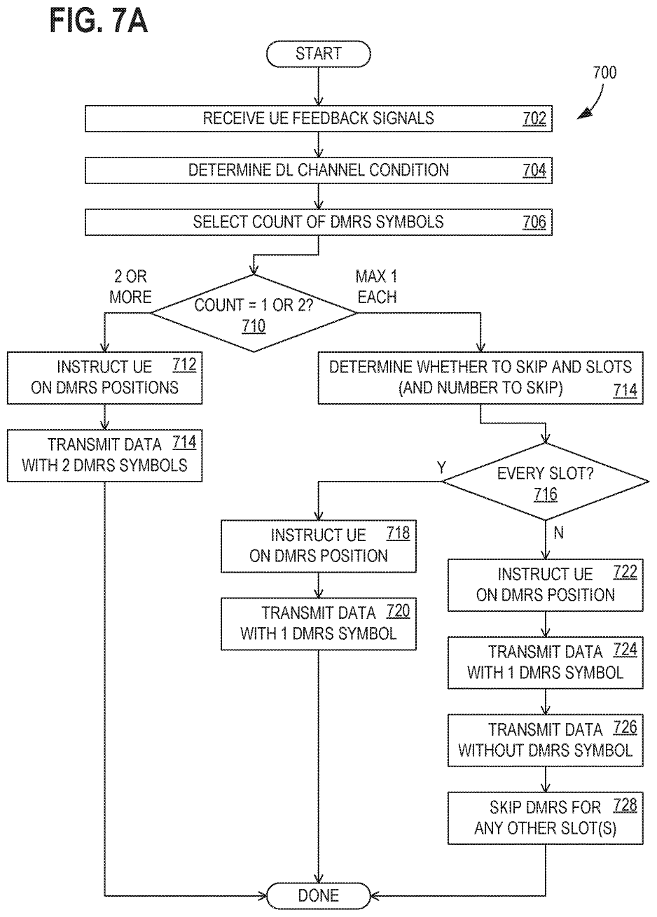

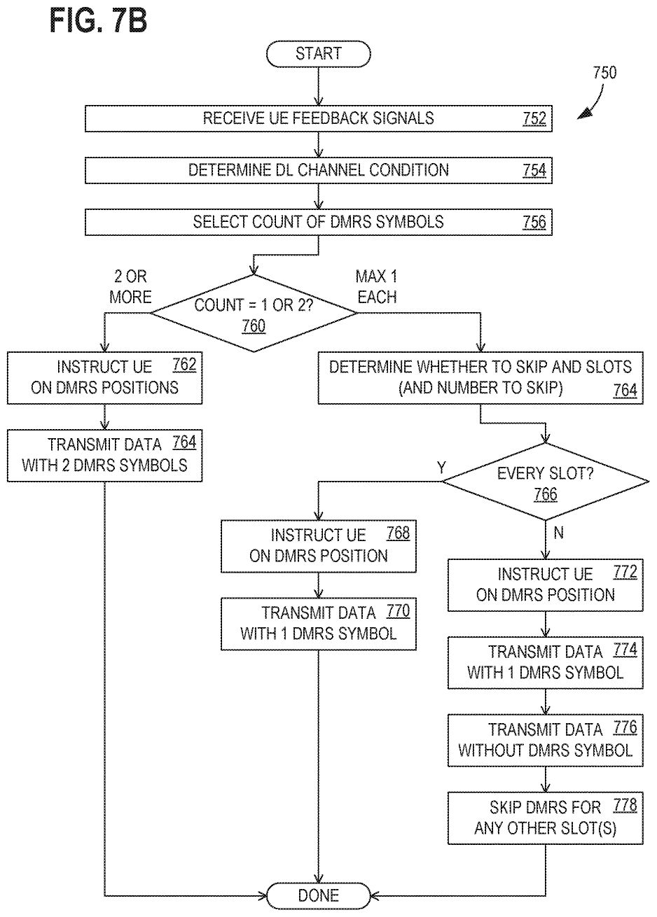

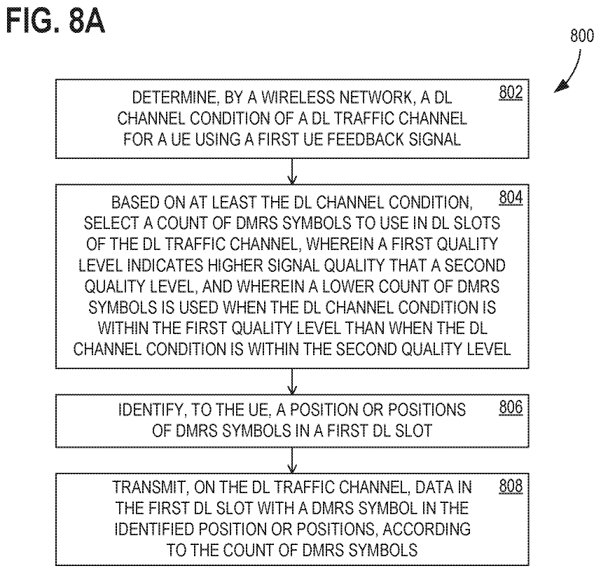

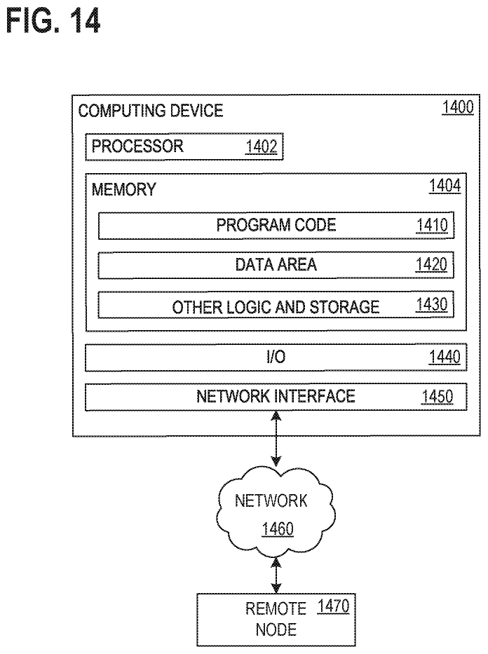

FIG. 7A illustrates a flowchart 700 of exemplary operations associated with examples of architecture 100. In some examples, at least a portion of flowchart 700 may be performed using one or more computing devices 1400 of FIG. 14. Flowchart 700 commences with base station 111 of wireless network 110, and thus DMRS selection logic 400, receiving a plurality of UE feedback signals 410 in operation 702. In operation 704, wireless network 110 (e.g., DMRS selection logic 400) determines (estimates) DL channel condition 310 of DL traffic channel 210 for UE 102 using at least UE feedback signal 410a, or in some examples, a plurality of UE feedback signals 410.

Operation 706 selects a count 412 of DMRS symbols 214 to use in DL slots 500 of DL traffic channel 210, based on at least DL channel condition 310. A lower count of DMRS symbols 214 is used when DL channel condition 310 is within quality level 311 than when DL channel condition 310 is within quality level 312. For example, count 412 is one for quality level 311, but is two for quality level 312. Determining count 412 directly from a plurality of UE feedback signals 410 in a single step is equivalent to the separate operations, in which determining count 412 directly is a proxy for determining the quality level of DL channel condition 310.

Decision operation 710 (which may be combined with decision operation 716) determines whether two or more DMRS symbols 214 are to be used, or only a single DMRS symbol 214. If two (or more) DMRS symbols 214 are to be used, base station 111 identifies positions 416 of DMRS symbols 214 in DL slot 500a to UE 102, in operation 710. Base station 111 transmits data 212 in DL slot 500a with DMRS symbols 214, in identified positions 416, according to count 412 of DMRS symbols 214, to UE 102 on DL traffic channel 210 in operation 712. Based on at least determining that DL channel condition 310 is within quality level 312, some examples also use a power boost for DMRS symbols 214 and/or avoid multiplexing DL traffic channel 210.

If only a single DMRS symbol 214 is to be used, operation 714 determines whether to include DMRS symbol 214 in each DL slot, or skip some DL slots, based on at least DL channel condition 310. In some examples, operation 714 is combined with operation 704 and/or operation 706, and determining whether to include DMRS symbol 214 in each DL slot is also a proxy for determining DL channel condition 310. In some examples, a DMRS symbol 214 is not included in each DL slot when DL channel condition 310 is within quality level 313, although a DMRS symbol 214 is included in each DL slot when DL channel condition 310 is within quality level 312 and within quality level 311 without being in quality level 313 (i.e., when quality level 313 is a subset of quality level 311).

Decision operation 716 (which may be combined with decision operation 710) determines that a DMRS symbol 214 is included in each DL slot; base station 111 identifies position 416a of DMRS symbol 214 in DL slot 500a to UE 102, in operation 718. Base station 111 transmits data 212 in DL slot 500a with DMRS symbol 214, in identified position 416a, according to count 412 of DMRS symbols 214, to UE 102 on DL traffic channel 210 in operation 720. Based on at least determining that DL channel condition 310 is within quality level 311, some examples do not use a power boost for DMRS symbols 214 and/or may multiplex DL traffic channel 210.

If one or more DL slots 500 are to be skipped (i.e., a DMRS symbol 214 is not included in each DL slot), base station 111 identifies position 416a of DMRS symbol 214 in DL slot 500a to UE 102, in operation 722. Base station 111 transmits data 212 in DL slot 500a with DMRS symbol 214, in identified position 416a, according to count 412 of DMRS symbols 214, to UE 102 on DL traffic channel 210 in operation 724. Base station 111 then transmits data 212 in DL slot 500c, without a DMRS symbol 214, to UE 102 on DL traffic channel 210 in operation 726. Base station 111 then transmits data 212 in any additional skipped DL slots 500, without a DMRS symbol 214, to UE 102 on DL traffic channel 210 in operation 728 (i.e., skips N-2 more slots).

FIG. 7B illustrates a flowchart 750 of exemplary operations associated with examples of architecture 100. In some examples, at least a portion of flowchart 750 may be performed using one or more computing devices 1400 of FIG. 14. Flowchart 750 is the equivalent of flowchart 700 of FIG. 7A, but whereas flowchart 700 is for DL, flowchart 750 is for UL. All clarifications, such as regarding optional operations and equivalent operations described for flowchart 700, also apply to flowchart 750, where operations correspond.

Flowchart 750 commences with base station 111 of wireless network 110, and thus DMRS selection logic 400, receiving a plurality of UE reference signals 450 in operation 752. In operation 754, wireless network 110 (e.g., DMRS selection logic 400) determines (estimates) UL channel condition 350 of UL traffic channel 250 for UE 102 using at least UE reference signal 450a, or in some examples, a plurality of UE reference signals 450.

Operation 756 selects count 452 of DMRS symbols 254 to use in UL slots 600 of UL traffic channel 250, based on at least UL channel condition 350. A lower count of DMRS symbols 254 is used when UL channel condition 350 is within quality level 351 than when UL channel condition 350 is within quality level 352. Decision operation 760 determines whether two or more DMRS symbols 254 are to be used, or only a single DMRS symbol 254. If two (or more) DMRS symbols 254 are to be used, base station 111 identifies positions 456 of DMRS symbols 254 in UL slot 600a to UE 102, in operation 760. Base station 111 transmits data 252 in UL slot 600a with DMRS symbols 254, in identified positions 456, according to count 452 of DMRS symbols 254, to UE 102 on UL traffic channel 250 in operation 762. Based on at least determining that UL channel condition 350 is within quality level 352, some examples also use a power boost for DMRS symbols 254 and/or avoid multiplexing UL traffic channel 250.

If only a single DMRS symbol 254 is to be used, operation 764 determines whether to include DMRS symbol 254 in each UL slot, or skip some UL slots, based on at least UL channel condition 350. In some examples, operation 764 is combined with operation 754 and/or operation 756, and determining whether to include DMRS symbol 254 in each UL slot is also a proxy for determining UL channel condition 350. In some examples, a DMRS symbol 254 is not included in each UL slot when UL channel condition 350 is within quality level 353, although a DMRS symbol 254 is included in each UL slot when UL channel condition 350 is within quality level 352 and within quality level 351 without being in quality level 353 (i.e., when quality level 353 is a subset of quality level 351).

Decision operation 766 (which may be combined with decision operation 760) determines that a DMRS symbol 254 is included in each UL slot; base station 111 identifies position 456a of DMRS symbol 254 in UL slot 600a to UE 102, in operation 768. Base station 111 transmits data 252 in UL slot 600a with DMRS symbol 254, in identified position 456a, according to count 452 of DMRS symbols 254, to UE 102 on UL traffic channel 250 in operation 770. Based on at least determining that UL channel condition 350 is within quality level 351, some examples do not use a power boost for DMRS symbols 254 and/or may multiplex UL traffic channel 250.

If one or more UL slots 600 are to be skipped (i.e., a DMRS symbol 254 is not included in each UL slot), base station 111 identifies position 456a of DMRS symbol 254 in UL slot 600a to UE 102, in operation 772. Base station 111 transmits data 252 in UL slot 600a with DMRS symbol 254, in identified position 456a, according to count 452 of DMRS symbols 254, to UE 102 on UL traffic channel 250 in operation 774. Base station 111 then transmits data 252 in UL slot 600b, without a DMRS symbol 254, to UE 102 on UL traffic channel 250 in operation 776. Base station 111 then transmits data 252 in any additional skipped UL slots 600, without a DMRS symbol 254, to UE 102 on UL traffic channel 250 in operation 778 (i.e., skips N-2 more slots).

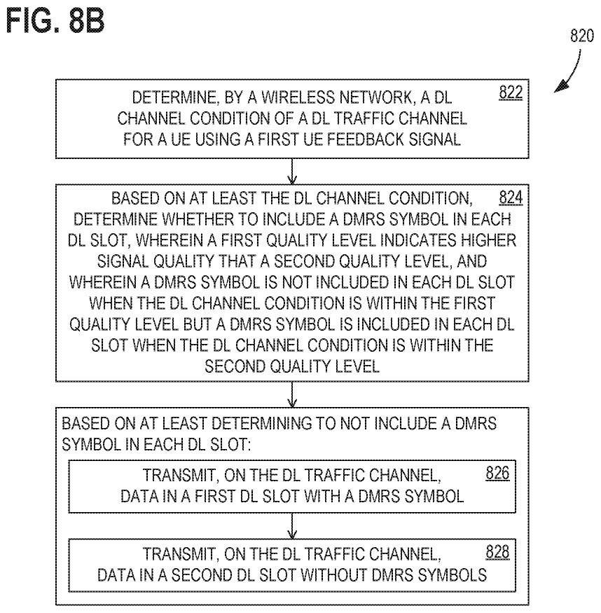

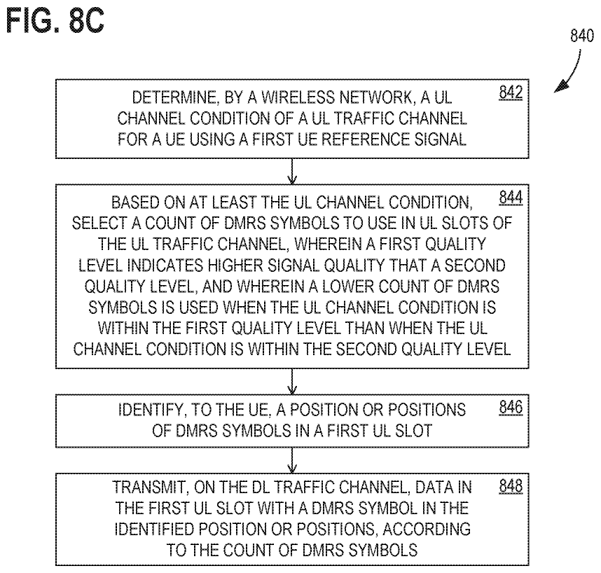

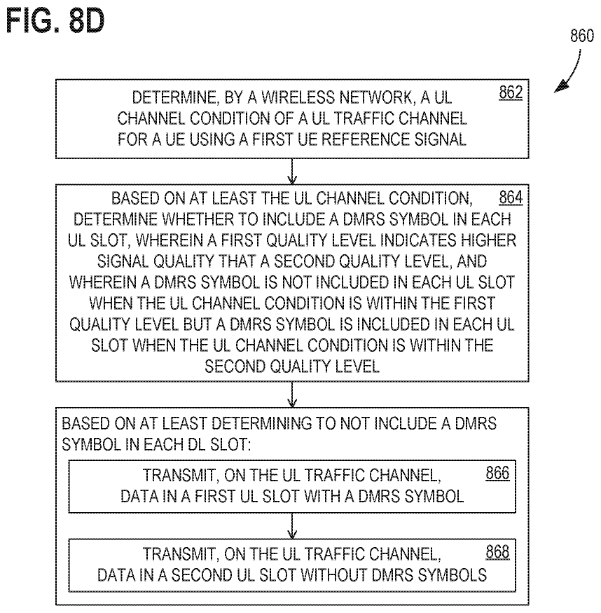

FIG. 8A illustrates a flowchart 800 of exemplary operations associated with architecture 100. In some examples, at least a portion of flowchart 800 may be performed using one or more computing devices 1400 of FIG. 14. Flowchart 800 commences with operation 802, which includes determining, by a wireless network, a DL channel condition of a DL traffic channel for a UE using a first UE feedback signal.

Operation 804 includes, based on at least the DL channel condition, selecting a count of DMRS symbols to use in DL slots of the DL traffic channel, wherein a first quality level indicates higher signal quality than a second quality level, and wherein a lower count of DMRS symbols is used when the DL channel condition is within the first quality level than when the DL channel condition is within the second quality level. Operation 806 includes identifying, to the UE, a position or positions of DMRS symbols in a first DL slot. Operation 808 includes transmitting, on the DL traffic channel, data in the first DL slot with a DMRS symbol in the identified position or positions, according to the count of DMRS symbols.

FIG. 8B illustrates a flowchart 820 of exemplary operations associated with architecture 100. In some examples, at least a portion of flowchart 820 may be performed using one or more computing devices 1400 of FIG. 14. Flowchart 820 commences with operation 822, which includes determining, by a wireless network, a DL channel condition of a DL traffic channel for a UE using a first UE feedback signal.

Operation 824 includes, based on at least the DL channel condition, determining whether to include a DMRS symbol in each DL slot, wherein a first quality level indicates higher signal quality than a second quality level, and wherein a DMRS symbol is not included in each DL slot when the DL channel condition is within the first quality level but a DMRS symbol is included in each DL slot when the DL channel condition is within the second quality level. Operations 826 and 828 are based on at least determining to not include a DMRS symbol in each DL slot. Operation 826 includes transmitting, on the DL traffic channel, data in a first DL slot with a DMRS symbol. Operation 828 includes transmitting, on the DL traffic channel, data in a second DL slot without DMRS symbols.

FIG. 8C illustrates a flowchart 840 of exemplary operations associated with architecture 100. In some examples, at least a portion of flowchart 840 may be performed using one or more computing devices 1400 of FIG. 14. Flowchart 840 commences with operation 842, which includes determining, by a wireless network, a UL channel condition of a UL traffic channel for a UE using a first UE reference signal.

Operation 844 includes, based on at least the UL channel condition, selecting a count of DMRS symbols to use in UL slots of the UL traffic channel, wherein a first quality level indicates higher signal quality than a second quality level, and wherein a lower count of DMRS symbols is used when the UL channel condition is within the first quality level than when the UL channel condition is within the second quality level. Operation 846 includes identifying, to the UE, a position or positions of DMRS symbols in a first UL slot. Operation 848 includes transmitting, on the UL traffic channel, data in the first UL slot with a DMRS symbol in the identified position or positions, according to the count of DMRS symbols.

FIG. 8D illustrates a flowchart 860 of exemplary operations associated with architecture 100. In some examples, at least a portion of flowchart 860 may be performed using one or more computing devices 1400 of FIG. 14. Flowchart 860 commences with operation 862, which includes determining, by a wireless network, a UL channel condition of a UL traffic channel for a UE using a first UE reference signal.

Operation 864 includes, based on at least the UL channel condition, determining whether to include a DMRS symbol in each UL slot, wherein a first quality level indicates higher signal quality than a second quality level, and wherein a DMRS symbol is not included in each UL slot when the UL channel condition is within the first quality level but a DMRS symbol is included in each UL slot when the UL channel condition is within the second quality level. Operations 866 and 868 are based on at least determining to not include a DMRS symbol in each UL slot. Operation 866 includes transmitting, on the UL traffic channel, data in a first UL slot with a DMRS symbol. Operation 868 includes transmitting, on the UL traffic channel, data in a second UL slot without DMRS symbols.

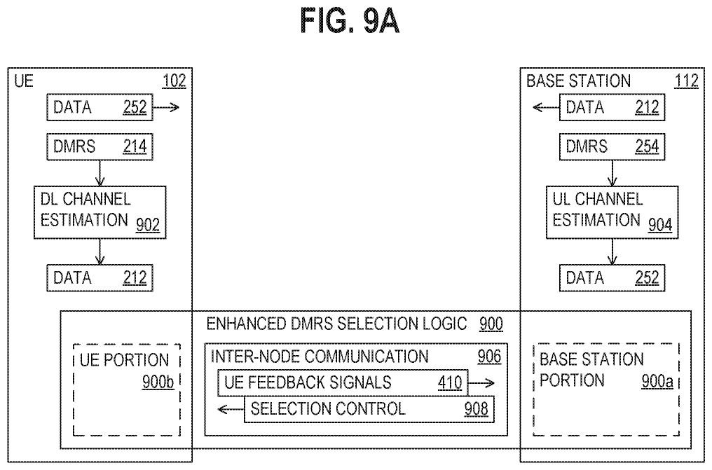

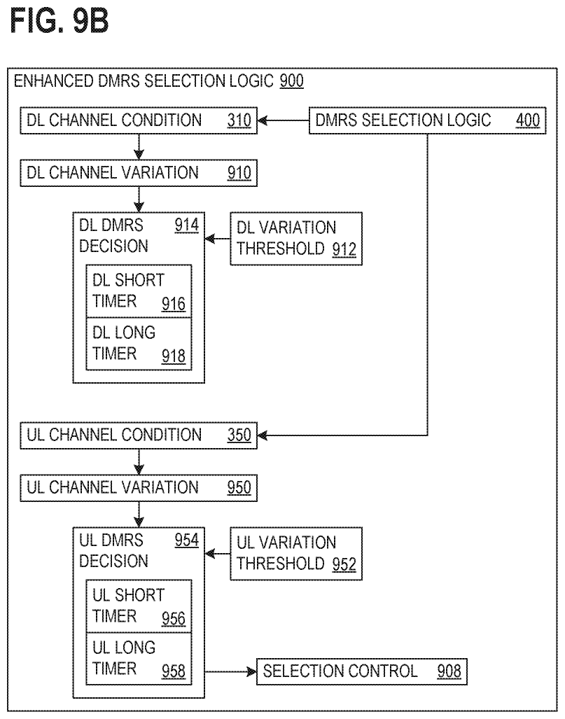

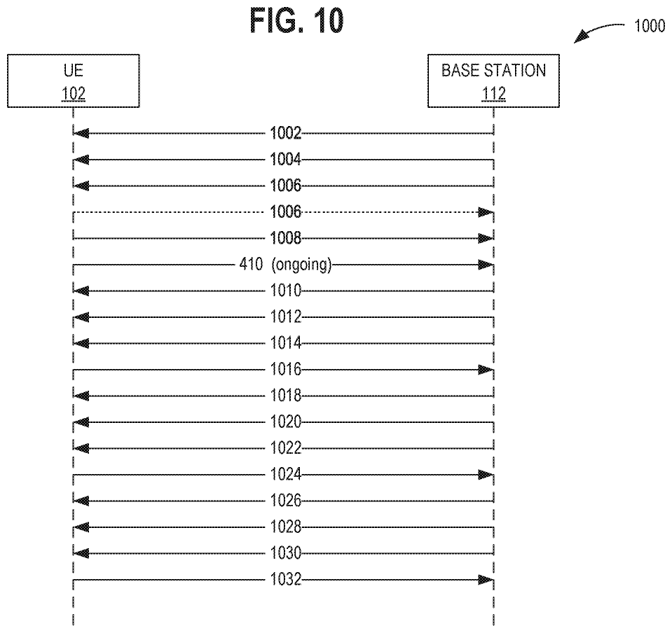

FIGS. 9A and 9B illustrate an enhanced DMRS selection logic 900, which has the capabilities and functionality described for DMRS selection logic 400 of FIG. 4, along with additional capabilities and functionality. Considering first FIG. 9A, enhanced DMRS selection logic 900 has functionality that spans from base station 112 to UE 102, with a base station portion 900a and a UE portion 900b. An internode communication functionality 906 passes UE feedback signals 410 from UE 102 to base station portion 900a of enhanced DMRS selection logic 900 within base station 112. Additionally, internode communication functionality 906 passes DMRS selection control instructions 908 from base station 112 to UE 102, for example to instruct UE 102 whether to include a DMRS symbol 254 in UL transmissions, and, if so, how many and where to place them in UL slots. DMRS selection control instructions 908 may take the form of UL scheduling message 1006, UL scheduling message 1014, UL scheduling message 1022, and UL scheduling message 1030, which are shown in FIG. 10.

UE 102 has data 252 to transmit to wireless network 110, and receives data 212 from wireless network 110. UE 102 uses DMRS symbol 214, received from base station 112 of wireless network, in a DL slot, to generate a DL channel estimation 902. UE 102 stores DL channel estimation 902 until a new DMRS symbol 214 is received, and uses DL channel estimation 902 to decode data 212. In some examples, UE 102 interpolates between two versions of DL channel estimation 902, generated with two different instances of DMRS symbol 214, to decode the portion of data 212 that is received between the two instances of DMRS symbol 214. When a DL slot skips DMRS symbol 214, UE 102 retains the version of DL channel estimation 902 that had been generated with the most recently received instance of DMRS symbol 214.

Similarly, base station 112 uses DMRS symbol 254, received from UE 102, in a UL slot, to generate a UL channel estimation 904. Base station 112 stores UL channel estimation 904 until a new DMRS symbol 254 is received, and uses UL channel estimation 904 to decode data 252. In some examples, base station 112 interpolates between two versions of UL channel estimation 904, generated with two different instances of DMRS symbol 254, to decode the portion of data 252 that is received between the two instances of DMRS symbol 254. When a UL slot skips DMRS symbol 254, base station 112 retains the version of UL channel estimation 904 that had been generated with the most recently received instance of DMRS symbol 254.

Turning now to FIG. 9B, enhanced DMRS selection logic 900 is shown as containing DMRS selection logic 400, so that enhanced DMRS selection logic 900 is capable of performing at least all of the functionality described above for DMRS selection logic 400. Enhanced DMRS selection logic 900 has DL channel condition 310, which varies over time, so that enhanced DMRS selection logic 900 is able to determine a DL channel variation 910, which is the variation (with time) of DL channel condition 310.

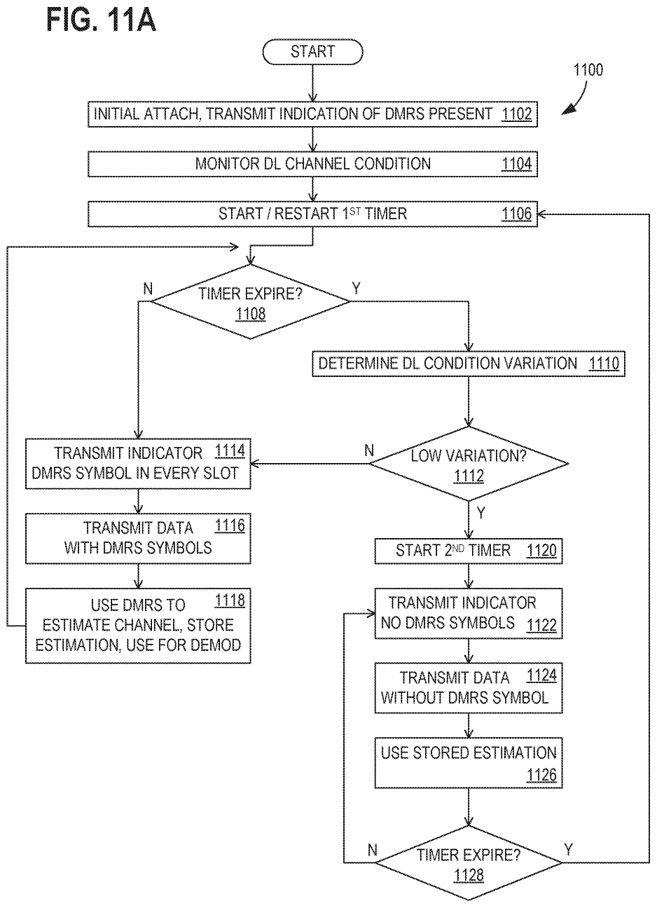

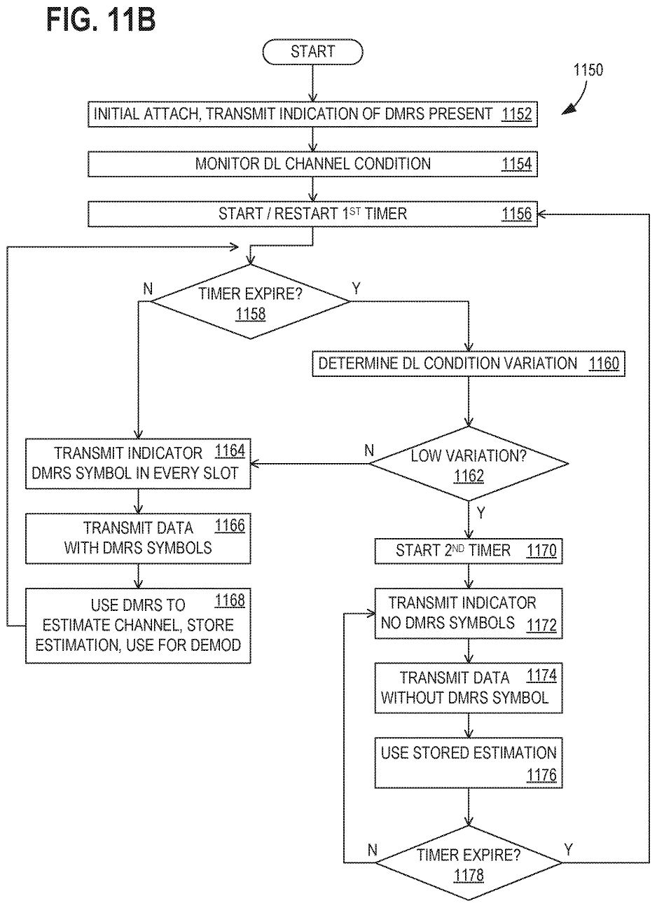

The more rapidly DL channel condition 310 changes, the higher is DL channel variation 910, and so the more often a new version of DL channel estimation 902 is needed. In contrast, when DL channel condition 310 is stable (i.e., relatively unchanging) with lower DL channel variation 910, there is less of a need to generate a new version of DL channel estimation 902. This is what enables lengthening the time between transmitting two instances of DMRS symbol 214. In some examples, DL channel estimation 902 is compared with a DL channel variation threshold 912, in order to determine whether to transmit a new instance of DMRS symbol 214. A DL DMRS decision logic 914 uses DL channel variation threshold 912 and two timers, a DL short timer 916 and a DL long timer 918, to determine whether to transmit DMRS symbol 214, based on the value of DL channel variation 910. The operation of DL DMRS decision logic 914 is described in relation to FIG. 11A.

In some examples, DL long timer 918 is set to a value between 10 milliseconds (ms) and 200 ms, inclusive, and DL long timer 918 is set to a value between 500 ms and 100 seconds(s), inclusive. UEs that are expected to remain stationary, such as FWAs, may use shorter values for DL long timer 918, such as between 10 ms and 100 ms, and longer values for DL long timer 918, such as between 1 s and 100 s. Highly mobile UEs, such as smartphones, may use longer values for DL long timer 918, such as between 100 ms and 200 ms, and shorter values for DL long timer 918, such as between 500 ms and 2 s. DL long timer 918 and DL long timer 918 may be set and adjusted, as desired, by the operator of wireless network 110.

Enhanced DMRS selection logic 900 also has UL channel condition 350, which varies over time, so that enhanced DMRS selection logic 900 is able to determine a UL channel variation 950, which is the variation (with time) of UL channel condition 350. The more rapidly UL channel condition 350 changes, the higher is UL channel variation 950, and so the more often a new version of UL channel estimation 904 is needed. In contrast, when UL channel condition 350 is stable (i.e., relatively unchanging) with lower UL channel variation 950, there is less of a need to generate a new version of UL channel estimation 904. This is what enables lengthening the time between transmitting two instances of DMRS symbol 254. In some examples, UL channel estimation 904 is compared with a UL channel variation threshold 952, in order to determine whether to transmit a new instance of DMRS symbol 254. A UL DMRS decision logic 954 uses UL channel variation threshold 952 and two timers, a UL short timer 956 and a UL long timer 958, to determine whether to transmit DMRS symbol 254, based on the value of UL channel variation 950. The operation of UL DMRS decision logic 954 is described in relation to FIG. 11B.

In some examples, short timer 956 is set to a value between 10 ms and 200 ms, inclusive, and long timer 958 is set to a value between 500 ms and 100 s, inclusive. UEs that are expected to remain stationary, such as FWAs, may use shorter values for short timer 956, such as between 10 ms and 100 ms, and longer values for long timer 958, such as between 1 s and 100 s. Highly mobile UEs, such as smartphones, may use longer values for short timer 956, such as between 100 ms and 200 ms, and shorter values for long timer 958, such as between 500 ms and 2 s. Short timer 956 and long timer 958 may be set and adjusted, as desired, by the operator of wireless network 110.

FIG. 10 shows a message sequence diagram 1000 of messages that flow between UE 102 and base station 112. The specific messages are referenced and explained in the descriptions of FIGS. 11A and 11B.

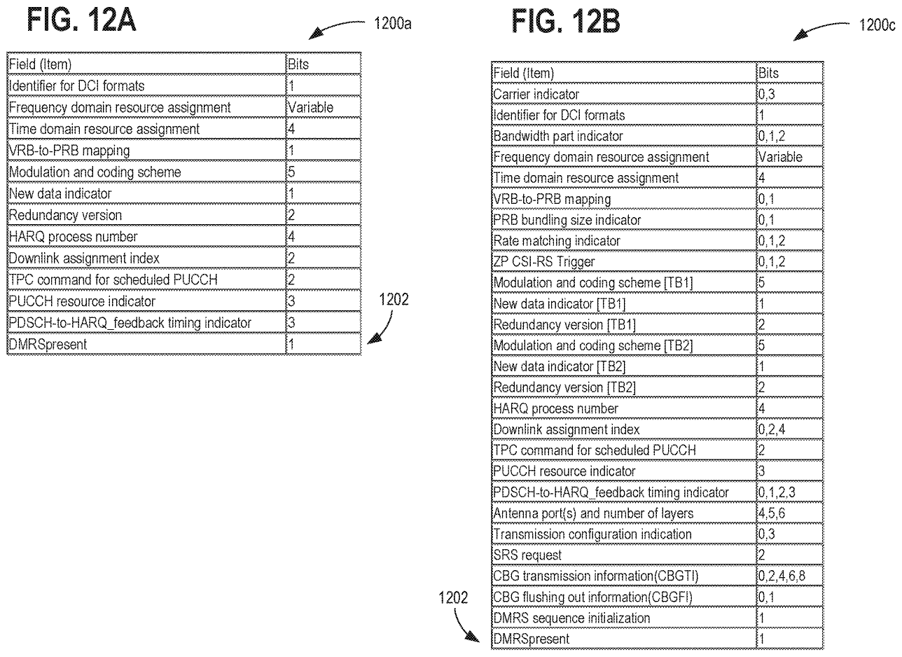

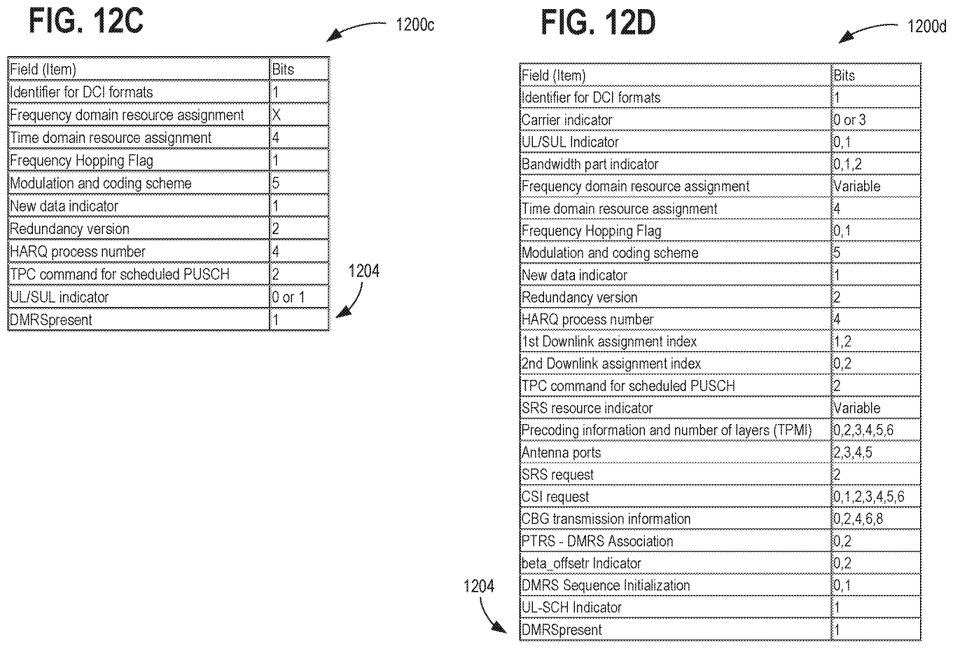

FIG. 11A illustrates a flowchart 1100 of exemplary operations associated with examples of architecture 100. In some examples, at least a portion of flowchart 1100 may be performed using one or more computing devices 1400 of FIG. 14. Flowchart 1100 commences with setting an indicator 1202, a DMRS present indicator, to “true”, and transmitting a DL scheduling message 1002 to UE 102 in operation 1102. DL scheduling message 1002 has indicator 1202 that identifies that a DL slot 1004 includes DMRS symbol 214. Base station 112 also transmits data 212 in DL slot 1004 to UE 102 in operation 1102. Examples of DL scheduling message 1002 are shown in FIGS. 12A and 12B.

Turning briefly to FIGS. 12A and 12B, examples of DCI messages are shown. FIG. 12A shows a table representing bit fields of a DCI Format 1_0 message 1200a. Indicator 1202 is a bit field at the end of the table labeled as “DMRSpresent”, and in some examples, is a single bit wide. FIG. 12B shows a table representing bit fields of a DCI Format 1_1 message 1200b. Indicator 1202 is also shown as a single bit wide bit field at the end of the table, and is labeled as “DMRSpresent”. For a single bit wide field, a bit value of 1 may represent a “true” condition, and a bit value of “0” may represent a “false” condition. In some examples, indicator 1202 is two bits wide, with the numerical value indicating the count of DMRS symbols in the next DL slot, ranging from 0 (bits=“00”) up to a maximum of 3 (bits=“11”).

During the initial attach of UE 102, until attach success, base station 112 sets DMRSpresent to true, or some other non-zero value. Later, when (if) indicator 1202 is 0 (whether one or two bits wide), no DMRS symbol will be present in the next DL slot, and instead, the space that is not used for a DMRS symbol is instead used for additional data. The current channel estimation will be reused for slots with no DMRS symbol until a new DMRS symbol is sent.

In some examples, DL scheduling message 1002 comprises a DCI message, such as a DCI Format 1_0 message 1200a or a DCI Format 1_1 message 1200b. In some examples, DL slot 1004 is a version of first DL slot 500a or second DL slot 500b of FIGS. 5A and 5B, respectively.

Monitoring of variation 910 of DL channel condition 310 begins in operation 1104, and remains ongoing, along with UE 102 providing continuous updates of UE feedback signals 410. DL DMRS decision logic 914 starts DL short timer 916 in operation 1106. A decision operation 1108 determines whether DL long timer 918 has expired. If DL short timer 916 has not yet expired, flowchart 1100 moves to operation 1114, which is described below. During the time prior to expiration of DL short timer 916, all DL slots are sent with DMRS symbol 214. When DL short timer 916 does expire, DL DMRS decision logic 914 determines variation 910 of DL channel condition 310 in operation 1110.

A decision operation 1112 determines whether variation 910 of DL channel condition 310 is below DL channel variation threshold 912. In some examples, this is the determination of whether to include DMRS symbol 214 in each DL slot. If variation 910 of DL channel condition 310 is not below DL channel variation threshold 912 (i.e., variation 910 of DL channel condition 310 exceeds DL channel variation threshold 912), operation 1114 sets indicator 1202 (DMRSpresent) to true or some number ranging from 1 to 3, inclusive, and wireless network 110 (base station 112) transmits indicator 1202 to UE 102 in a DL scheduling message 1010. Wireless network 110 then transmits data 212 and indicator 1202 to UE 102 in a DL slot 1012 in operation 1116.

DL scheduling message 1010 has indicator 1202 that identifies that DL slot 1012 includes DMRS symbol 214, and in some examples, DL scheduling message 1010 comprises a DCI message, such as a DCI Format 1_0 message 1200a or a DCI Format 1_1 message 1200b. DL slot 1012 includes DMRS symbol 214. In some examples, DL slot 1012 is a version of first DL slot 500a or second DL slot 500b. The default operation is currently that wireless network 110 will transmit at least one DMRS symbol 214 in every DL slot until DL DMRS decision logic 914 detects that variation 910 of DL channel condition 310 is below DL channel variation threshold 912.

In operation 1118, UE 102 uses DMRS symbol 214 to derive DL channel estimation 902 and uses DL channel estimation 902 for demodulating the PDSCH (DL traffic channel 210). UE 102 will store DL channel estimation 902 until it is replaced when a new DMRS symbol 214 is sent, whether in the next DL slot, or some other future DL slot. Flowchart 1100 then returns to operation 1106 to restart DL short timer 916.

When decision operation 1112 determines that variation 910 of DL channel condition 310 is below DL channel variation threshold 912, DL DMRS decision logic 914 starts DL long timer 918 in operation 1120. In operation 1122, DMRS decision logic 914 sets indicator 1202 (DMRSpresent) to false or zero (0), and wireless network 110 transmits indicator 1202 to UE 102 in a DL scheduling message 1018. Wireless network 110 then transmits data 212 to UE 102 in a DL slot 1020 in operation 1124. In operation 1126, UE 102 uses the stored DL channel estimation 902 for demodulating the PDSCH (DL traffic channel 210).

Indicator 1202 in DL scheduling message 1018 identifies that DL slot 1020 does not include DMRS symbol 214. At this point, the default operation is that wireless network 110 will not transmit a DMRS symbol 214 in a DL slot until DL DMRS decision logic 914 detects that variation 910 of DL channel condition 310 exceeds DL channel variation threshold 912, or some other time-out condition occurs. In some examples, DL scheduling message 1018 comprises a DCI message, such as a DCI Format 1_0 message 1200a or a DCI Format 1_1 message 1200b. DL slot 1020 does not include DMRS symbol 214, and in some examples, DL slot 1020 is a version of third DL slot 500c of FIG. 5C.

A decision operation 1128 determines whether DL long timer 918 has expired. When DL long timer 918 expires, flowchart 1100 returns to operation 1106 to restart DL short timer 916. However, if DL long timer 918 has not expired, flowchart 1100 returns to operation 1122. In this second pass through operation 1122, prior to expiration of DL long timer 918, wireless network 110 transmits indicator 1202 in DL scheduling message 1026 to UE 102. Indicator 1202 in DL scheduling message 1026 identifies that a DL slot 1028 does not include DMRS symbol 214. In operation 1124, wireless network 110 transmits data 212 to UE 102. In some examples, DL scheduling message 1026 comprises a DCI message, such as a DCI Format 1_0 message 1200a or a DCI Format 1_1 message 1200b. DL slot 1028 does not include DMRS symbol 214, and in some examples, DL slot 1028 is a version of third DL slot 500c of FIG. 5C.

FIG. 11B illustrates a flowchart 1150 of exemplary operations associated with examples of architecture 100. In some examples, at least a portion of flowchart 1150 may be performed using one or more computing devices 1400 of FIG. 14. Flowchart 1150 commences with setting an indicator 1204, a DMRS present indicator, to “true”, and transmitting a UL scheduling message 1006 to UE 102 in operation 1152. UL scheduling message 1006 has indicator 1204 that identifies that a UL slot 1008 should not include DMRS symbol 254. UE 102 transmits data 252 in UL slot 1008 to wireless network 110 (base station 112) in operation 1152. Examples of UL scheduling message 1006 are shown in FIGS. 12C and 12D, when indicator 1204 is in a DCI message. In some examples, indicator 1204 may be in a UCI message, or UE 102 may transmit indicator 1204 to wireless network 110. This is shown as the dotted line from UE 102 to base station 112 in FIG. 10.

Turning briefly to FIGS. 12C and 12D, examples of DCI messages are shown. FIG. 12C shows a table representing bit fields of a DCI Format 0_0 message 1200c. Indicator 1204 is a bit field at the end of the table labeled as “DMRSpresent”, and in some examples, is a single bit wide. FIG. 12D shows a table representing bit fields of a DCI Format 0_1 message 1200d. Indicator 1204 is also shown as a single bit wide bit field at the end of the table, and is labeled as “DMRSpresent”. For a single bit wide field, a bit value of 1 may represent a “true” condition, and a bit value of “0” may represent a “false” condition. In some examples, indicator 1204 is two bits wide, with the numerical value indicating the count of DMRS symbols in the next UL slot, ranging from 0 (bits=“00”) up to a maximum of 3 (bits=“11”).

During the initial attach of UE 102, until attach success, base station 112 sets DMRSpresent to true, or some other non-zero value. Later, when (if) indicator 1204 is 0 (whether one or two bits wide), no DMRS symbol will be present in the next UL slot, and instead, the space that is not used for a DMRS symbol is instead used for additional data. The current channel estimation will be reused for slots with no DMRS symbol until a new DMRS symbol is sent.

In some examples, UL scheduling message 1006 comprises a DCI message, such as a DCI Format 0_0 message 1200c or a DCI Format 0_1 message 1200d. In some examples, UL slot 1008 is a version of first UL slot 500a or second UL slot 500b of FIGS. 5A and 5B, respectively.

Monitoring of variation 950 of UL channel condition 350 begins in operation 1154, and remains ongoing. UL DMRS decision logic 954 starts UL short timer 956 in operation 1156. A decision operation 1158 determines whether UL long timer 958 has expired. If UL short timer 956 has not yet expired, flowchart 1150 moves to operation 1164, which is described below. During the time prior to expiration of UL short timer 956, all UL slots are sent with DMRS symbol 254. When UL short timer 956 does expire, UL DMRS decision logic 954 determines variation 950 of UL channel condition 350 in operation 1160.

A decision operation 1162 determines whether variation 950 of UL channel condition 350 is below UL channel variation threshold 952. In some examples, this is the determination of whether to include DMRS symbol 254 in each UL slot. If variation 950 of UL channel condition 350 is not below UL channel variation threshold 952 (i.e., variation 950 of UL channel condition 350 exceeds UL channel variation threshold 952), operation 1164 sets indicator 1204 (DMRSpresent) to true or some number ranging from 1 to 3, inclusive, and wireless network 110 (base station 112) transmits indicator 1204 to UE 102 in a UL scheduling message 1014. UE 102 then transmits data 252 and indicator 1204 to wireless network 110 in a UL slot 1016 in operation 1166.

UL scheduling message 1014 has indicator 1204 that identifies that UL slot 1016 should not include DMRS symbol 254, and in some examples, UL scheduling message 1014 comprises a DCI message, such as a DCI Format 0_0 message 1200c or a DCI Format 0_1 message 1200d. UL slot 1016 does not include DMRS symbol 254. In some examples, UL slot 1016 is a version of first UL slot 500a or second UL slot 500b. The default operation is currently that UE 102 will transmit at least one DMRS symbol 254 in every UL slot until UL DMRS decision logic 954 detects that variation 950 of UL channel condition 350 is below UL channel variation threshold 952.

In operation 1168, base station 112 uses DMRS symbol 254 to derive UL channel estimation 904 and uses UL channel estimation 904 for demodulating the PUSCH (UL traffic channel 250). Base station 112 will store UL channel estimation 904 until it is replaced when a new DMRS symbol 254 is sent, whether in the next UL slot, or some other future UL slot. Flowchart 1150 then returns to operation 1156 to restart UL short timer 956.

When decision operation 1162 determines that variation 950 of UL channel condition 350 is below UL channel variation threshold 952, UL DMRS decision logic 954 starts UL long timer 958 in operation 1170. In operation 1172, DMRS decision logic 954 sets indicator 1204 (DMRSpresent) to false or zero (0), and wireless network 110 transmits indicator 1204 to UE 102 in a UL scheduling message 1022. UE 102 then transmits data 252 to wireless network 110 in a UL slot 1024 in operation 1174. In operation 1176, base station 112 uses the stored UL channel estimation 904 for demodulating the PUSCH (UL traffic channel 250).

Indicator 1204 in UL scheduling message 1022 identifies that UL slot 1024 should not include DMRS symbol 254. At this point, the default operation is that UE 102 will not transmit a DMRS symbol 254 in a UL slot until UL DMRS decision logic 954 detects that variation 950 of UL channel condition 350 exceeds UL channel variation threshold 952, or some other time-out condition occurs. In some examples, UL scheduling message 1022 comprises a DCI message, such as a DCI Format 0_0 message 1200c or a DCI Format 0_1 message 1200d. UL slot 1024 does not include DMRS symbol 254, and in some examples, UL slot 1024 is a version of third UL slot 500c of FIG. 5C.

A decision operation 1178 determines whether UL long timer 958 has expired. When UL long timer 958 expires, flowchart 1150 returns to operation 1156 to restart UL short timer 956. However, if UL long timer 958 has not expired, flowchart 1150 returns to operation 1172. In this second pass through operation 1172, prior to expiration of UL long timer 958, wireless network 110 transmits indicator 1204 in UL scheduling message 1030 to UE 102. Indicator 1204 in UL scheduling message 1030 identifies that a UL slot 1032 should not include DMRS symbol 254. In operation 1174, UE 102 transmits data 252 to wireless network 110. In some examples, UL scheduling message 1030 comprises a DCI message, such as a DCI Format 0_0 message 1200c or a DCI Format 0_1 message 1200d. UL slot 1032 does not include DMRS symbol 254, and in some examples, UL slot 1032 is a version of third UL slot 500c of FIG. 5C.

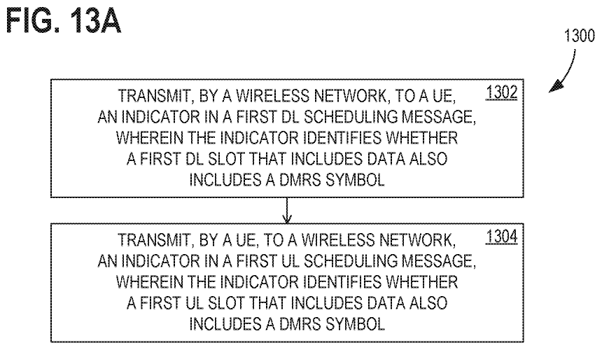

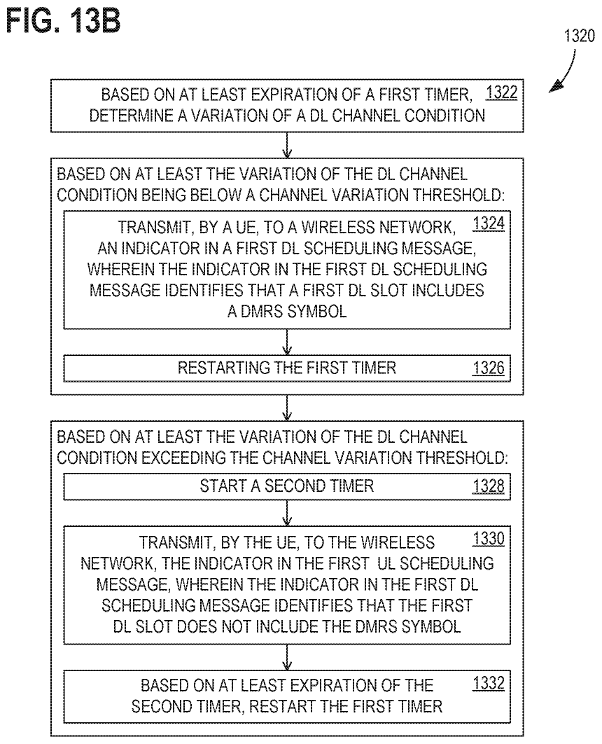

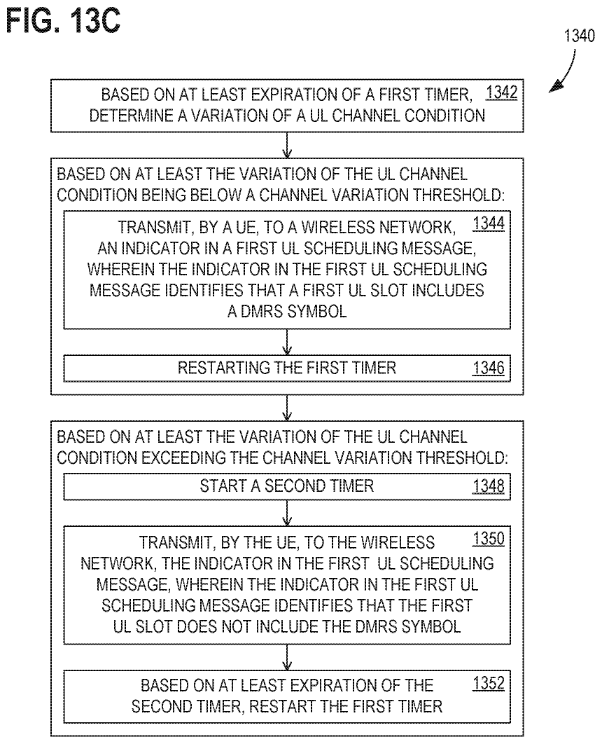

FIG. 13A illustrates a flowchart 1300 of exemplary operations associated with architecture 100. In some examples, at least a portion of flowchart 1300 may be performed using one or more computing devices 1400 of FIG. 14. Flowchart 1300 commences with operation 1302, which includes transmitting, by a wireless network, to a UE, an indicator in a first DL scheduling message, wherein the indicator identifies whether a first DL slot includes a DMRS symbol. Operation 1304 includes transmitting, by a UE, to a wireless network, an indicator in a first UL scheduling message, wherein the indicator identifies whether a first UL slot includes a DMRS symbol.

FIG. 13B illustrates a flowchart 1320 of exemplary operations associated with architecture 100. In some examples, at least a portion of flowchart 1320 may be performed using one or more computing devices 1400 of FIG. 14. Flowchart 1320 commences with operation 1322, which includes, based on at least the expiration of a first timer, determining a variation of a DL channel condition.

Operations 1324-1326 are performed if the variation of the DL channel condition is below a channel variation threshold. Operation 1324 includes transmitting, by a wireless network, to a UE, an indicator in a first DL scheduling message, wherein the indicator in the first DL scheduling message identifies that a first DL slot includes a DMRS symbol. Operation 1326 includes restarting the first timer.

Operations 1328-1332 are performed if the variation of the DL channel condition exceeds the channel variation threshold. Operation 1328 includes starting a second timer. Operation 1330 includes transmitting, by the wireless network, to the UE, the indicator in the first DL scheduling message, wherein the indicator in the first DL scheduling message identifies that the first DL slot does not include the DMRS symbol. Operation 1332 includes, based on at least the expiration of the second timer, restarting the first timer.

FIG. 13C illustrates a flowchart 1340 of exemplary operations associated with architecture 100. In some examples, at least a portion of flowchart 1340 may be performed using one or more computing devices 1400 of FIG. 14. Flowchart 1340 commences with operation 1342, which includes, based on at least the expiration of a first timer, determining a variation of a UL channel condition.

Operations 1344-1346 are performed if the variation of the UL channel condition is below a channel variation threshold. Operation 1344 includes transmitting, by a UE, to a wireless network, an indicator in a first UL scheduling message, wherein the indicator in the first UL scheduling message identifies that a first UL slot includes a DMRS symbol. Operation 1346 includes restarting the first timer.

Operations 1348-1352 are performed if the variation of the UL channel condition exceeds the channel variation threshold. Operation 1348 includes starting a second timer. Operation 1350 includes transmitting, by the UE, to the wireless network, the indicator in the first UL scheduling message, wherein the indicator in the first UL scheduling message identifies that the first UL slot does not include the DMRS symbol. Operation 1352 includes, based on at least the expiration of the second timer, restarting the first timer.

FIG. 14 illustrates a block diagram of computing device 1400 that may be used as any component described herein that may require computational or storage capacity (e.g., a computer storage device). Computing device 1400 has at least a processor 1402 and a memory 1404 that holds program code 1410, data area 1420, and other logic and storage 1430. Memory 1404 is any device allowing information, such as computer-executable instructions and/or other data, to be stored and retrieved. For example, memory 1404 may include one or more random access memory (RAM) modules, flash memory modules, hard disks, solid-state disks, persistent memory devices, and/or optical disks. Program code 1410 comprises computer-executable instructions and computer-executable components, including instructions used to perform operations described herein. Data area 1420 holds data used to perform operations described herein. Memory 1404 also includes other logic and storage 1430 that performs or facilitates other functions disclosed herein or otherwise required of computing device 1400. An input/output (I/O) component 1440 facilitates receiving input from users and other devices and generating displays for users and outputs for other devices. A network interface 1450 permits communication over an external computer network 1460 (e.g., computer network 124) with a remote node 1470, which may represent another implementation of computing device 1400. For example, a remote node 1470 may represent another of the above-noted nodes within architecture 100.

### Additional Examples

An example system comprises: a processor; and a computer-readable medium storing instructions that are operative upon execution by the processor to: determine, by a wireless network, a DL channel condition of a DL traffic channel for a UE using a first UE feedback signal; based on at least the DL channel condition, select a count of DMRS symbols to use in DL slots of the DL traffic channel, wherein a first quality level indicates higher signal quality than a second quality level, and wherein a lower count of DMRS symbols is used when the DL channel condition is within the first quality level than when the DL channel condition is within the second quality level; identify, to the UE, a position or positions of DMRS symbols in a first DL slot; and transmit, on the DL traffic channel, data in the first DL slot with a DMRS symbol in the identified position or positions, according to the count of DMRS symbols.

Another example system comprises: a processor; and a computer-readable medium storing instructions that are operative upon execution by the processor to: determine, by a wireless network, a DL channel condition of a DL traffic channel for a UE using a first UE feedback signal; based on at least the DL channel condition, determine whether to include a DMRS symbol in each DL slot, wherein a first quality level indicates higher signal quality than a second quality level, and wherein a DMRS symbol is not included in each DL slot when the DL channel condition is within the first quality level but a DMRS symbol is included in each DL slot when the DL channel condition is within the second quality level; and based on at least determining to not include a DMRS symbol in each DL slot: transmit, on the DL traffic channel, data in a first DL slot with a DMRS symbol; and transmit, on the DL traffic channel, data in a second DL slot without DMRS symbols.

Another example system comprises: a processor; and a computer-readable medium storing instructions that are operative upon execution by the processor to: determine, by a wireless network, a UL channel condition of a UL traffic channel for a UE using a first UE reference signal; based on at least the UL channel condition, select a count of DMRS symbols to use in UL slots of the UL traffic channel, wherein a first quality level indicates higher signal quality than a second quality level, and wherein a lower count of DMRS symbols is used when the UL channel condition is within the first quality level than when the UL channel condition is within the second quality level; identify, to the UE, a position or positions of DMRS symbols in a first UL slot; and transmit, on the UL traffic channel, data in the first UL slot with a DMRS symbol in the identified position or positions, according to the count of DMRS symbols.

Another example system comprises: a processor; and a computer-readable medium storing instructions that are operative upon execution by the processor to: determine, by a wireless network, a UL channel condition of a UL traffic channel for a UE using a first UE reference signal; based on at least the UL channel condition, determine whether to include a DMRS symbol in each UL slot, wherein a first quality level indicates higher signal quality than a second quality level, and wherein a DMRS symbol is not included in each UL slot when the UL channel condition is within the first quality level but a DMRS symbol is included in each UL slot when the UL channel condition is within the second quality level; and based on at least determining to not include a DMRS symbol in each UL slot: transmit, on the UL traffic channel, data in a first UL slot with a DMRS symbol; and transmit, on the UL traffic channel, data in a second UL slot without DMRS symbols.

Another example system comprises: a processor; and a computer-readable medium storing instructions that are operative upon execution by the processor to: transmit, by a wireless network, to a UE, an indicator in a first DL scheduling message, wherein the indicator identifies whether a first DL slot that includes data also includes a DMRS symbol.

Another example system comprises: a processor; and a computer-readable medium storing instructions that are operative upon execution by the processor to: transmit, by a UE, to a wireless network, an indicator in a first UL scheduling message, wherein the indicator identifies whether a first UL slot that includes data also includes a DMRS symbol.

Another example system comprises: a processor; and a computer-readable medium storing instructions that are operative upon execution by the processor to: based on at least the expiration of a first timer, determine a variation of a DL channel condition; based on at least the variation of the DL channel condition being below a channel variation threshold: transmit, by a wireless network, to a UE, an indicator in a first DL scheduling message, wherein the indicator in the first DL scheduling message identifies that a first DL slot includes a DMRS symbol; and restart the first timer; and based on at least the variation of the DL channel condition exceeding the channel variation threshold: start a second timer; transmit, by the wireless network, to the UE, the indicator in the first DL scheduling message, wherein the indicator in the first DL scheduling message identifies that the first DL slot does not include the DMRS symbol; and based on at least the expiration of the second timer, restart the first timer.

Another example system comprises: a processor; and a computer-readable medium storing instructions that are operative upon execution by the processor to: based on at least the expiration of a first timer, determine a variation of a UL channel condition; based on at least the variation of the UL channel condition being below a channel variation threshold: transmit, by a UE, to a wireless network, an indicator in a first UL scheduling message, wherein the indicator in the first UL scheduling message identifies that a first UL slot includes a DMRS symbol; and restart the first timer; and based on at least the variation of the UL channel condition exceeding the channel variation threshold: start a second timer; transmit, by the UE, to the wireless network, the indicator in the first UL scheduling message, wherein the indicator in the first UL scheduling message identifies that the first UL slot does not include the DMRS symbol; and based on at least the expiration of the second timer, restart the first timer.

An example method of wireless communication comprises: determining, by a wireless network, a DL channel condition of a DL traffic channel for a UE using a first UE feedback signal; based on at least the DL channel condition, selecting a count of DMRS symbols to use in DL slots of the DL traffic channel, wherein a first quality level indicates higher signal quality than a second quality level, and wherein a lower count of DMRS symbols is used when the DL channel condition is within the first quality level than when the DL channel condition is within the second quality level; identifying, to the UE, a position or positions of DMRS symbols in a first DL slot; and transmitting, on the DL traffic channel, data in the first DL slot with a DMRS symbol in the identified position or positions, according to the count of DMRS symbols.

Another example method of wireless communication comprises: determining, by a wireless network, a DL channel condition of a DL traffic channel for a UE using a first UE feedback signal; based on at least the DL channel condition, determining whether to include a DMRS symbol in each DL slot, wherein a first quality level indicates higher signal quality than a second quality level, and wherein a DMRS symbol is not included in each DL slot when the DL channel condition is within the first quality level but a DMRS symbol is included in each DL slot when the DL channel condition is within the second quality level; and based on at least determining to not include a DMRS symbol in each DL slot: transmitting, on the DL traffic channel, data in a first DL slot with a DMRS symbol; and transmitting, on the DL traffic channel, data in a second DL slot without DMRS symbols.

Another example method of wireless communication comprises: determining, by a wireless network, a UL channel condition of a UL traffic channel for a UE using a first UE reference signal; based on at least the UL channel condition, selecting a count of DMRS symbols to use in UL slots of the UL traffic channel, wherein a first quality level indicates higher signal quality than a second quality level, and wherein a lower count of DMRS symbols is used when the UL channel condition is within the first quality level than when the UL channel condition is within the second quality level; identifying, to the UE, a position or positions of DMRS symbols in a first UL slot; and transmitting, on the UL traffic channel, data in the first UL slot with a DMRS symbol in the identified position or positions, according to the count of DMRS symbols.

Another example method of wireless communication comprises: determining, by a wireless network, a UL channel condition of a UL traffic channel for a UE using a first UE reference signal; based on at least the UL channel condition, determining whether to include a DMRS symbol in each UL slot, wherein a first quality level indicates higher signal quality than a second quality level, and wherein a DMRS symbol is not included in each UL slot when the UL channel condition is within the first quality level but a DMRS symbol is included in each UL slot when the UL channel condition is within the second quality level; and based on at least determining to not include a DMRS symbol in each UL slot: transmitting, on the UL traffic channel, data in a first UL slot with a DMRS symbol; and transmitting, on the UL traffic channel, data in a second UL slot without DMRS symbols.

Another example method of wireless communication comprises: transmitting, by a wireless network, to a UE, an indicator in a first DL scheduling message, wherein the indicator identifies whether a first DL slot that includes data also includes a DMRS symbol.

Another example method of wireless communication comprises: transmitting, by a UE, to a wireless network, an indicator in a first UL scheduling message, wherein the indicator identifies whether a first UL slot that includes data also includes a DMRS symbol.

Another example method of wireless communication comprises: based on at least (upon) expiration of a first timer, determining a variation of a DL channel condition; based on at least the variation of the DL channel condition being below a channel variation threshold: transmitting, by a wireless network, to a UE, an indicator in a first DL scheduling message, wherein the indicator in the first DL scheduling message identifies that a first DL slot includes a DMRS symbol; and restarting the first timer; and based on at least the variation of the DL channel condition exceeding the channel variation threshold: starting a second timer; transmitting, by the wireless network, to the UE, the indicator in the first DL scheduling message, wherein the indicator in the first DL scheduling message identifies that the first DL slot does not include the DMRS symbol; and based on at least expiration of the second timer, restarting the first timer.

Another example method of wireless communication comprises: based on at least (upon) the expiration of a first timer, determining a variation of a UL channel condition; based on at least the variation of the UL channel condition being below a channel variation threshold: transmitting, by a UE, to a wireless network, an indicator in a first UL scheduling message, wherein the indicator in the first UL scheduling message identifies that a first UL slot includes a DMRS symbol; and restarting the first timer; and based on at least the variation of the UL channel condition exceeding the channel variation threshold: starting a second timer; transmitting, by the UE, to the wireless network, the indicator in the first UL scheduling message, wherein the indicator in the first UL scheduling message identifies that the first UL slot does not include the DMRS symbol; and based on at least the expiration of the second timer, restarting the first timer.

One or more example computer storage devices have computer-executable instructions stored thereon, which, upon execution by a computer, cause the computer to perform operations comprising: determining, by a wireless network, a DL channel condition of a DL traffic channel for a UE using a first UE feedback signal; based on at least the DL channel condition, selecting a count of DMRS symbols to use in DL slots of the DL traffic channel, wherein a first quality level indicates higher signal quality than a second quality level, and wherein a lower count of DMRS symbols is used when the DL channel condition is within the first quality level than when the DL channel condition is within the second quality level; identifying, to the UE, a position or positions of DMRS symbols in a first DL slot; and transmitting, on the DL traffic channel, data in the first DL slot with a DMRS symbol in the identified position or positions, according to the count of DMRS symbols.

One or more example computer storage devices have computer-executable instructions stored thereon, which, upon execution by a computer, cause the computer to perform operations comprising: determining, by a wireless network, a DL channel condition of a DL traffic channel for a UE using a first UE feedback signal; based on at least the DL channel condition, determining whether to include a DMRS symbol in each DL slot, wherein a first quality level indicates higher signal quality than a second quality level, and wherein a DMRS symbol is not included in each DL slot when the DL channel condition is within the first quality level but a DMRS symbol is included in each DL slot when the DL channel condition is within the second quality level; and based on at least determining to not include a DMRS symbol in each DL slot: transmitting, on the DL traffic channel, data in a first DL slot with a DMRS symbol; and transmitting, on the DL traffic channel, data in a second DL slot without DMRS symbols.

One or more example computer storage devices have computer-executable instructions stored thereon, which, upon execution by a computer, cause the computer to perform operations comprising: determining, by a wireless network, a UL channel condition of a UL traffic channel for a UE using a first UE reference signal; based on at least the UL channel condition, selecting a count of DMRS symbols to use in UL slots of the UL traffic channel, wherein a first quality level indicates higher signal quality than a second quality level, and wherein a lower count of DMRS symbols is used when the UL channel condition is within the first quality level than when the UL channel condition is within the second quality level; identifying, to the UE, a position or positions of DMRS symbols in a first UL slot; and transmitting, on the UL traffic channel, data in the first UL slot with a DMRS symbol in the identified position or positions, according to the count of DMRS symbols.

One or more example computer storage devices have computer-executable instructions stored thereon, which, upon execution by a computer, cause the computer to perform operations comprising: determining, by a wireless network, a UL channel condition of a UL traffic channel for a UE using a first UE reference signal; based on at least the UL channel condition, determining whether to include a DMRS symbol in each UL slot, wherein a first quality level indicates higher signal quality than a second quality level, and wherein a DMRS symbol is not included in each UL slot when the UL channel condition is within the first quality level but a DMRS symbol is included in each UL slot when the UL channel condition is within the second quality level; and based on at least determining to not include a DMRS symbol in each UL slot: transmitting, on the UL traffic channel, data in a first UL slot with a DMRS symbol; and transmitting, on the UL traffic channel, data in a second UL slot without DMRS symbols.

One or more example computer storage devices have computer-executable instructions stored thereon, which, upon execution by a computer, cause the computer to perform operations comprising: transmitting, by a wireless network, to a UE, an indicator in a first DL scheduling message, wherein the indicator identifies whether a first DL slot that includes data also includes a DMRS symbol.

One or more example computer storage devices have computer-executable instructions stored thereon, which, upon execution by a computer, cause the computer to perform operations comprising: transmitting, by a UE, to a wireless network, an indicator in a first UL scheduling message, wherein the indicator identifies whether a first UL slot that includes data also includes a DMRS symbol.

One or more example computer storage devices have computer-executable instructions stored thereon, which, upon execution by a computer, cause the computer to perform operations comprising: based on at least the expiration of a first timer, determining a variation of a DL channel condition; based on at least the variation of the DL channel condition being below a channel variation threshold: transmitting, by a wireless network, to a UE, an indicator in a first DL scheduling message, wherein the indicator in the first DL scheduling message identifies that a first DL slot includes a DMRS symbol; and restarting the first timer; and based on at least the variation of the DL channel condition exceeding the channel variation threshold: starting a second timer; transmitting, by the wireless network, to the UE, the indicator in the first DL scheduling message, wherein the indicator in the first DL scheduling message identifies that the first DL slot does not include the DMRS symbol; and based on at least the expiration of the second timer, restarting the first timer.

One or more example computer storage devices have computer-executable instructions stored thereon, which, upon execution by a computer, cause the computer to perform operations comprising: based on at least the expiration of a first timer, determining a variation of a UL channel condition; based on at least the variation of the UL channel condition being below a channel variation threshold: transmitting, by a UE, to a wireless network, an indicator in a first UL scheduling message, wherein the indicator in the first UL scheduling message identifies that a first UL slot includes a DMRS symbol; and restarting the first timer; and based on at least the variation of the UL channel condition exceeding the channel variation threshold: starting a second timer; transmitting, by the UE, to the wireless network, the indicator in the first UL scheduling message, wherein the indicator in the first UL scheduling message identifies that the first UL slot does not include the DMRS symbol; and based on at least the expiration of the second timer, restarting the first timer.

Alternatively, or in addition to the other examples described herein, examples include any combination of the following:
the wireless network comprises a cellular network;
the UE comprises an eMBB, a cellphone, an FWA, a CPE, an IoT device, an M2M communication device, or a PC with a cellular modem;
the DMRS symbols are 5G DMRS symbols;
the count of DMRS symbols is one for the first quality level;
the count of DMRS symbols is two for the second quality level;
when the count is one, the position is 7, or 2, or 11;
when the count is two, the positions are 2 and 11;
based on at least the DL channel condition, determining whether to include a DMRS symbol in each DL slot;
a DMRS symbol is not included in each DL slot when the DL channel condition is within the first quality level but a DMRS symbol is included in each DL slot when the DL channel condition is within the second quality level;
based on at least determining to not include a DMRS symbol in each DL slot, transmitting, on the DL traffic channel, data in a second DL slot without DMRS symbols;
based on at least determining to not include a DMRS symbol in each DL slot, determining how many subsequent DL slots in which to not include a DMRS symbol, such that DMRS symbols are transmitted only every N DL slots;
N is greater than 1;
based on at least determining that the DL channel condition is within the first quality level, multiplexing the DL traffic channel and/or not using a power boost for the DMRS symbols;
based on at least determining that the DL channel condition is within the second quality level, using a power boost for the DMRS symbols and/or not multiplexing the DL traffic channel;
determining the DL channel condition of the DL channel uses a plurality of UE feedback signals that include the first UE feedback signal;
each UE feedback signal of the plurality of UE feedback signals comprises CSI or an MR;
the DL channel condition is within the first quality level when the DL channel condition exceeds a first signal quality threshold for a plurality of UE feedback signals that include the first UE feedback signal;
an AI model determines the DL channel condition or selects the count of DMRS symbols using the plurality of UE feedback signals;
the DL traffic channel comprises a PDSCH;
based on at least the DL channel condition, selecting a count of DMRS symbols to use in DL slots of the DL traffic channel;
a lower count of DMRS symbols is used when the DL channel condition is within the first quality level than when the DL channel condition is within the second quality level;
identifying, to the UE, a position or positions of DMRS symbols in a first DL slot;
transmitting data in the first DL slot comprises transmitting the data with a DMRS symbol in the identified position or positions, according to the count of DMRS symbols;
an AI model determines the DL channel condition or determines whether to include a DMRS symbol in each DL slot;
based on at least the UL channel condition, determining whether to include a DMRS symbol in each UL slot;
a DMRS symbol is not included in each UL slot when the UL channel condition is within the first quality level, but a DMRS symbol is included in each UL slot when the UL channel condition is within the second quality level;
based on at least determining to not include a DMRS symbol in each UL slot, transmitting, on the UL traffic channel, data in a second UL slot without DMRS symbols;
based on at least determining to not include a DMRS symbol in each UL slot, determining how many subsequent UL slots in which to not include a DMRS symbol, such that DMRS symbols are transmitted only every N UL slots;
based on at least determining that the UL channel condition is within the first quality level, multiplexing the UL traffic channel and/or not using a power boost for the DMRS symbols;
based on at least determining that the UL channel condition is within the second quality level, using a power boost for the DMRS symbols and/or not multiplexing the UL traffic channel;
determining the UL channel condition of the UL channel uses a plurality of UE reference signals that include the first UE reference signal;
each UE reference signal of the plurality of UE reference signals comprises a DMRS symbol on the UL traffic channel or an SRS;
the UL channel condition is within the first quality level when the UL channel condition exceeds a first signal quality threshold for a plurality of UE reference signals that include the first UE reference signal;
an AI model determines the UL channel condition or selects the count of DMRS symbols using the plurality of UE reference signals;
the UL traffic channel comprises a PUSCH;
based on at least the UL channel condition, selecting a count of DMRS symbols to use in UL slots of the UL traffic channel;
a lower count of DMRS symbols is used when the UL channel condition is within the first quality level than when the UL channel condition is within the second quality level;
identifying, to the UE, a position or positions of DMRS symbols in a first UL slot;
transmitting data in the first UL slot comprises transmitting the data with a DMRS symbol in the identified position or positions, according to the count of DMRS symbols;
an AI model determines the UL channel condition or determines whether to include a DMRS symbol in each UL slot;
receiving the plurality of UE feedback signals;
receiving the plurality of UE reference signals;
determining the DL channel condition comprises estimating the DL channel condition;
determining the UL channel condition comprises estimating the UL channel condition;
a base station of the wireless network performs the DL channel condition and/or the UL channel condition determinations;
the base station comprises a gNB or an eNB;
the CSI comprises a HARQ ACK signal, a HARQ NACK signal, a CQI, or a PMI;
the MR comprises RSRP, RSRQ, or SINR;
the count of DMRS symbols is for a single frequency in a DL slot or a UL slot;
the DL channel condition is within a third quality level when the DL channel condition exceeds a second signal quality threshold;
the third quality level indicates higher signal quality than the first quality level;
a DMRS symbol is not included in each DL slot when the DL channel condition is within the third quality level;
a DMRS symbol is included in each DL slot when the DL channel condition is within the first quality level but not within the third quality level;
the UL channel condition is within a third quality level when the UL channel condition exceeds a second signal quality threshold;
the third quality level indicates higher signal quality than the first quality level;
a DMRS symbol is not included in each UL slot when the UL channel condition is within the third quality level;
a DMRS symbol is included in each UL slot when the UL channel condition is within the first quality level but not within the third quality level;
the first DL scheduling message comprises a DCI message;
the first DL scheduling message comprises a DCI Format 1_0 message or a DCI Format 1_1 message;
the indicator comprises a DMRSpresent field;
the indicator comprises a single bit wide field;
transmitting, by the wireless network, to the UE, data in the first DL slot;
the first DL slot does not include the DMRS symbol;
the indicator in the first DL scheduling message identifies that the first DL slot does not include the DMRS symbol;
transmitting, by the wireless network, to the UE, the indicator in a second DL scheduling message;
the indicator in the second DL scheduling message identifies that a second DL slot includes the DMRS symbol;
transmitting, by the wireless network, to the UE, data and the DMRS symbol in the second DL slot;
determining whether to include the DMRS symbol in each DL slot;
the first UL scheduling message comprises a DCI message or a UCI message;
the DCI message comprises a DCI Format 0_0 message or a DCI Format 0_1 message;
transmitting, by the UE, to the wireless network, data in the first UL slot;
the first UL slot does not include the DMRS symbol;
the indicator in the first UL scheduling message identifies that the first UL slot does not include the DMRS symbol;
transmitting, by the UE, to the wireless network, the indicator in a second UL scheduling message;
the indicator in the second UL scheduling message identifies that a second UL slot includes the DMRS symbol;
transmitting, by the UE, to the wireless network, data and the DMRS symbol in the second UL slot;
determining whether to include the DMRS symbol in each UL slot;
prior to expiration of the second timer: transmitting, by the wireless network, to the UE, the indicator in a third DL scheduling message, wherein the indicator in the third DL scheduling message identifies that the third DL slot does not include the DMRS symbol; and transmitting, by the wireless network, to the UE, data in the third DL slot, wherein the third DL slot does not include the DMRS symbol;
monitoring the variation of the DL channel condition;
the first timer is set to a value between 10 ms and 200 ms, inclusive;
the second timer is set to a value between 500 ms and 100 s, inclusive;
prior to expiration of the second timer: transmitting, by the UE, to the wireless network, the indicator in a third UL scheduling message, wherein the indicator in the third UL scheduling message identifies that the third UL slot does not include the DMRS symbol; and transmitting, by the UE, to the wireless network, data in the third UL slot, wherein the third UL slot does not include the DMRS symbol; and
monitoring the variation of the UL channel condition.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of signaling demodulation reference signal (DMRS) symbol presence, the method comprising:
transmitting, by a wireless network, to a user equipment (UE), an indicator in a first downlink (DL) scheduling message, wherein the indicator identifies whether a first DL slot includes one or more DMRS symbols, the first DL slot carrying data.

2. The method of claim 1, wherein the first DL scheduling message comprises a downlink control information (DCI) message.

3. The method of claim 2, wherein the first DL scheduling message comprises a DCI Format 1_0 message or a DCI Format 1_1 message.

4. The method of claim 1, wherein the indicator comprises a DMRSpresent field.

5. The method of claim 1, wherein the indicator comprises a single bit wide field.

6. The method of claim 1, further comprising:
transmitting, by the wireless network, to the UE, data in the first DL slot, wherein the first DL slot does not include the one or more DMRS symbols, and wherein the indicator in the first DL scheduling message identifies that the first DL slot does not include the one or more DMRS symbols;
transmitting, by the wireless network, to the UE, the indicator in a second DL scheduling message, wherein the indicator in the second DL scheduling message identifies that a second DL slot includes the one or more DMRS symbols; and
transmitting, by the wireless network, to the UE, data and the one or more DMRS symbols in the second DL slot.

7. The method of claim 1, further comprising:
determining whether to include the one or more DMRS symbols in each DL slot, wherein determining whether to include the one or more DMRS symbols in each DL slot is based at least one or more of DL channel condition, or access network type.

8. A system for signaling demodulation reference signal (DMRS) symbol presence, the system comprising:
a processor; and
a computer-readable medium storing instructions that, when executed by the processor, cause the processor to:
transmit, by a wireless network, to a user equipment (UE), an indicator in a first downlink (DL) scheduling message, wherein the indicator identifies whether a first DL slot includes one or more DMRS symbols, the first DL slot carrying data.

9. The system of claim 8, wherein the first DL scheduling message comprises a downlink control information (DCI) message.

10. The system of claim 9, wherein the first DL scheduling message comprises a DCI Format 1_0 message or a DCI Format 1_1 message.

11. The system of claim 8, wherein the indicator comprises a DMRSpresent field.

12. The system of claim 8, wherein the indicator comprises a single bit wide field.

13. The system of claim 8, wherein the instructions further cause the processor to:
transmit, by the wireless network, to the UE, data in the first DL slot, wherein the first DL slot does not include the one or more DMRS symbols, and wherein the indicator in the first DL scheduling message identifies that the first DL slot does not include the one or more DMRS symbols;
transmit, by the wireless network, to the UE, the indicator in a second DL scheduling message, wherein the indicator in the second DL scheduling message identifies that a second DL slot includes the one or more DMRS symbols; and
transmit, by the wireless network, to the UE, data and the one or more DMRS symbols in the second DL slot.

14. The system of claim 8, wherein the instructions further cause the processor to:
determine whether to include the one or more DMRS symbols in each DL slot, wherein determining whether to include the one or more DMRS symbols in each DL slot is based at least one or more of DL channel condition, or access network type.

15. One or more computer storage devices having computer-executable instructions stored thereon for signaling demodulation reference signal (DMRS) symbol presence, which, upon execution by a computer, cause the computer to perform operations comprising:
transmitting. by a wireless network, to a user equipment (UE), an indicator in a first downlink (DL) scheduling message, wherein the indicator identifies whether a first DL slot includes one or more DMRS symbols, the first DL slot carrying data.

16. The one or more computer storage devices of claim 15, wherein the first DL scheduling message comprises a downlink control information (DCI) message.

17. The one or more computer storage devices of claim 16, wherein the first DL scheduling message comprises a DCI Format 1_0 message or a DCI Format 1_1 message.

18. The one or more computer storage devices of claim 15, wherein the indicator comprises a DMRSpresent field.

19. The one or more computer storage devices of claim 15, wherein the indicator comprises a single bit wide field.

20. The one or more computer storage devices of claim 15, wherein the operations further comprise:
transmitting, by the wireless network, to the UE, data in the first DL slot, wherein the first DL slot does not include the one or more DMRS symbols, and wherein the indicator in the first DL scheduling message identifies that the first DL slot does not include the one or more DMRS symbols;
transmitting, by the wireless network, to the UE, the indicator in a second DL scheduling message, wherein the indicator in the second DL scheduling message identifies that a second DL slot includes the one or more DMRS symbols; and
transmitting, by the wireless network, to the UE, data and the one or more DMRS symbols in the second DL slot.
